(19) United States
(12) Patent Application Publication
(10) Pub. No.: US 2026/0263937 A1
(43) Pub. Date: Sep. 10, 2026

(54) ONE OR MORE NON-TRANSITORY COMPUTER-READABLE STORAGE MEDIA, GAME APPARATUS, GAME SYSTEM, AND COMPUTER-IMPLEMENTED METHOD

(71) Applicant: Nintendo Co., Ltd., Kyoto (JP)

(72) Inventors: Shinji KITAHARA, Kyoto (JP); Ryutaro TAKAHASHI, Kyoto (JP); Ginga KAMEI, Kyoto (JP); Naonori OHNISHI, Kyoto (JP)

(21) Appl. No.: 19/536,880

(22) Filed: Feb. 11, 2026

(30) Foreign Application Priority Data
Mar. 5, 2025 (JP) 2025-034196

(51) Int. Cl. A63F 13/58; A63F 13/42

(52) U.S. Cl. CPC A63F 13/58; A63F 13/42

(57) ABSTRACT

A state of a first character is transitioned from a first state to a second state in response to an operation input, and the first character in the second state is moved in response to an operation input. When a second character is placed near the first character, a parameter UI indicating a first parameter regarding a combination of the first character and the second character is displayed. The state of the first character is transitioned to the first state in response to an operation input. When at least the UI indicating the first parameter is displayed, if the state of the first character is transitioned from the second state to the first state, an event through which the first parameter is updated is caused to occur.

### CROSS REFERENCE TO RELATED APPLICATION

This application claims priority to Japanese Patent Application No. 2025-34196 filed on March 5, 2025, the entire contents of which are incorporated herein by reference.

### FIELD

The present disclosure relates to game processing in which an image of a virtual space is captured by a virtual camera that can be operated by a user.

### BACKGROUND AND SUMMARY

Conventionally, a game in which an in‑game event is caused to occur between a plurality of characters, has been known.

In the game as described above, there is room for improvement regarding display related to such an event.

In view of the above, the following configuration examples are exemplified.

### Configuration Example 1

Configuration Example 1 is directed to one or more non-transitory computer-readable storage media having stored therein instructions that, when executed, cause one or more processors to perform operations including:

in response to an operation input, transitioning a state of a first character, among a plurality of characters placed within a virtual space, from a first state to a second state;

in response to an operation input, moving the first character in the second state within the virtual space;

when the first character is in the second state and a second character among the plurality of characters is placed within a first range based on a position of the first character, displaying a parameter UI indicating a first parameter regarding a combination of the first character and the second character;

in response to an operation input, transitioning the state of the first character from the second state to the first state; and

when at least the UI indicating the first parameter is displayed, if the state of the first character is transitioned from the second state to the first state, causing an in‑game event, through which the first parameter is updated, to occur.

According to the above configuration example, when the first character is moved closer to the second character, the status of the first parameter associated with both characters can be checked, which helps a user decide whether to cause the in‑game event to occur.

### Configuration Example 2

In Configuration Example 2 based on Configuration Example 1 above, the operations may further include moving the first character in the first state within the virtual space, not based on an operation input by a user.

### Configuration Example 3

In Configuration Example 3 based on Configuration Example 1 or 2 above, the operations may further include: generating a game image, based on a virtual camera within the virtual space; and in response to a switching instruction based on an operation input, switching between a first camera mode in which the virtual camera is moved based on an operation input and a second camera mode in which the virtual camera is moved so as to follow movement of a character in the first state.

### Configuration Example 4

In Configuration Example 4 based on Configuration Example 3 above, the operations may further include, in the first camera mode: displaying a cursor UI indicating a position within the virtual space, the indicated position changing in response to an operation input; and when the position indicated by the cursor UI is included within a second range based on the position of the first character in the first state, switching to the second camera mode.

### Configuration Example 5

In Configuration Example 5 based on Configuration Example 3 above, the operations may further include, in the second camera mode, when the second character is placed within a third range based on the position of the first character followed by the virtual camera, displaying the UI indicating the first parameter.

### Configuration Example 6

In Configuration Example 6 based on Configuration Example 3 above, the operations may further include, in the second camera mode: displaying at least one or some of icons respectively corresponding to the plurality of characters, based on an operation input; displaying a UI indicating the first parameter regarding a combination of a character corresponding to the icon selected by an icon selection instruction based on an operation input and the first character followed by the virtual camera; and when an icon determination instruction based on an operation input is made for the selected icon, moving the first character to a position based on a position of the character corresponding to the icon.

### Configuration Example 7

In Configuration Example 7 based on Configuration Example 6 above, the operations may further include, when the icon determination instruction based on an operation input is made for the selected icon, moving the first character in the second state to a position based on the position of the character corresponding to the icon, and the first character in the second state may be moved such that the first character follows the character corresponding to the icon.

### Configuration Example 8

In Configuration Example 8 based on Configuration Example 2 above, the operations may further include: displaying a cursor UI indicating a position within the virtual space, the indicated position changing in response to an operation input; and when a character determination instruction based on an operation input is made in a state where the cursor UI overlaps the first character in the first state, transitioning the state of the first character from the first state to the second state.

### Configuration Example 9

In Configuration Example 9 based on Configuration Example 8 above, the operations may further include, when the first character in the first state is placed within a fourth range based on the position indicated by the cursor UI and the second character is placed within the first range based on the position of the first character, displaying the UI indicating the first parameter regarding a combination of the first character and the second character.

### Configuration Example 10

In Configuration Example 10 based on any one of Configuration Examples 1 to 9 above, the operations may further include: generating a game image, based on a virtual camera within the virtual space; changing a distance between the virtual camera and a virtual surface on which the first character is placed, based on an operation input; when the virtual surface and the virtual camera are separated from each other by more than a first distance and the first character is blocked by another object as seen from the virtual camera, displaying the other object so as to show that the first character is blocked; and when a determination instruction based on an operation input is made for the first character blocked by the other object, transitioning the state of the first character from the first state to the second state.

### Configuration Example 11

In Configuration Example 11 based on Configuration Example 10 above, the operations may further include, when a state of a third character is the second state, placing the virtual camera at a position separated from the virtual surface by more than the first distance.

### Configuration Example 12

In Configuration Example 12 based on Configuration Example 10 above, the operations may further include, when the distance between the virtual surface and the virtual camera is within the first distance and the first character is blocked by another object as seen from the virtual camera, displaying the other object without showing that the first character is blocked.

### Configuration Example 13

In Configuration Example 13 based on any one of Configuration Examples 1 to 12 above, the operations may further include: when the first character is in the second state and the second character among the plurality of characters is placed within the first range based on the position of the first character, further displaying a relationship UI indicating a relationship between the first character and the second character; and when a first condition which is satisfied at least by the first parameter reaching a first threshold value is satisfied, transitioning the relationship between the first character and the second character from a first relationship to a second relationship, and the first parameter may be updated such that the first parameter satisfies the first condition, through the in‑game event.

### Configuration Example 14

In Configuration Example 14 based on Configuration Example 13 above, types of the in‑game events occurring in the second relationship are more than types of the in‑game events occurring in the first relationship.

### CONFIGURATION EXAMPLE 15

In Configuration Example 15 based on Configuration Example 13 above, the operations may further include, while a second parameter of the first character satisfies a second condition: restricting occurrence of the in‑game event through which the first parameter of the first character and the second character having the first relationship with the first character is updated; and when at least the first parameter regarding a combination of the second character and the first character is indicated, if the state of the second character is transitioned from the second state to the first state, changing the second parameter such that the second condition is not satisfied.

### CONFIGURATION EXAMPLE 16

In Configuration Example 16 based on Configuration Example 13 above, the operations may further include: when the second parameter of the first character does not satisfy the second condition and a third condition based on the first character is satisfied based on an operation input, updating a third parameter of the first character; and when the second parameter of the first character satisfies the second condition and the third condition is satisfied based on an operation input, restricting update of the third parameter of the first character.

### CONFIGURATION EXAMPLE 17

In Configuration Example 17 based on Configuration Example 16 above, the operations may further include giving a first in-game item to a user at a specified timing, and an amount of the first in-game item given to the user when the third parameter of the first character has reached a second threshold value may be greater than an amount of the first in-game item given to the user when the third parameter of the first character has not reached the second threshold value.

### CONFIGURATION EXAMPLE 18

In Configuration Example 18, based on any one of Configuration Examples 1 to 17 above, the operations may further include giving a second in-game item to a user when a second parameter of the first character satisfies a fourth condition in accordance with the in‑game event based on the operation input.

Each configuration example described above may be applied to a computer-implemented method, a game system, and a game apparatus.

### BRIEF DESCRIPTION OF THE DRAWINGS

FIG. 1 shows a non-limiting example of a state in which a left controller 3 and a right controller 4 are attached to a main body apparatus 2;

FIG. 2 shows a non-limiting example of a state in which the left controller 3 and the right controller 4 are detached from the main body apparatus 2;

FIG. 3 is six orthogonal views showing a non-limiting example of the main body apparatus 2;

FIG. 4 is six orthogonal views showing a non-limiting example of the left controller 3;

FIG. 5 is six orthogonal views showing a non-limiting example of the right controller 4;

FIG. 6 is a block diagram showing a non-limiting example of the internal configuration of the main body apparatus 2;

FIG. 7 is a block diagram showing a non-limiting example of the internal configurations of the main body apparatus 2, the left controller 3, and the right controller 4;

FIG. 8 shows a non-limiting example of a game screen according to an exemplary embodiment;

FIG. 9 shows a non-limiting example of the game screen according to the exemplary embodiment;

FIG. 10 shows a non-limiting example of the game screen according to the exemplary embodiment;

FIG. 11 shows a non-limiting example of the game screen according to the exemplary embodiment;

FIG. 12 shows a non-limiting example of the game screen according to the exemplary embodiment;

FIG. 13 shows a non-limiting example of a first correlation display range;

FIG. 14 is a non-limiting example of an enlarged view of a correlation diagram image;

FIG. 15 shows a non-limiting example of the game screen according to the exemplary embodiment;

FIG. 16 is a non-limiting example of an enlarged view of a correlation diagram image;

FIG. 17 shows a non-limiting example of the game screen according to the exemplary embodiment;

FIG. 18 shows a non-limiting example of the game screen according to the exemplary embodiment;

FIG. 19 shows a non-limiting example of the game screen according to the exemplary embodiment;

FIG. 20 shows a non-limiting example of the game screen according to the exemplary embodiment;

FIG. 21 shows a non-limiting example of the game screen according to the exemplary embodiment;

FIG. 22 shows a non-limiting example of the game screen according to the exemplary embodiment;

FIG. 23 shows a non-limiting example of the game screen according to the exemplary embodiment;

FIG. 24 shows a non-limiting example of the game screen according to the exemplary embodiment;

FIG. 25 shows a non-limiting example of a second correlation display range;

FIG. 26 shows a non-limiting example of the game screen according to the exemplary embodiment;

FIG. 27 shows a non-limiting example of the game screen according to the exemplary embodiment;

FIG. 28 illustrates a non-limiting example of a camera mode;

FIG. 29 shows a non-limiting example of the game screen according to the exemplary embodiment;

FIG. 30 shows a non-limiting example of the game screen according to the exemplary embodiment;

FIG. 31 illustrates a non-limiting example of dither display;

FIG. 32 shows a non-limiting example of the game screen according to the exemplary embodiment;

FIG. 33 shows a non-limiting example of the game screen according to the exemplary embodiment;

FIG. 34 shows a non-limiting example of the game screen according to the exemplary embodiment;

FIG. 35 shows a non-limiting example of the game screen according to the exemplary embodiment;

FIG. 36 is a memory map showing a non-limiting example of various data stored in a DRAM 85;

FIG. 37 shows a non-limiting example of the data structure of virtual resident data 304;

FIG. 38 shows a non-limiting example of the data structure of event definition data 309;

FIG. 39 shows a non-limiting example of the data structure of operation data 317;

FIG. 40 is a non-limiting example of a flowchart showing the details of game processing according to the exemplary embodiment;

FIG. 41 is a non-limiting example of a flowchart showing the details of a free movement mode process;

FIG. 42 is a non-limiting example of a flowchart showing the details of a virtual resident control process;

FIG. 43 is a non-limiting example of a flowchart showing the details of a correlation diagram display control process;

FIG. 44 is a non-limiting example of a flowchart showing the details of an event occurrence determination process;

FIG. 45 is a non-limiting example of a flowchart showing the details of a cursor operation process;

FIG. 46 is a non-limiting example of a flowchart showing the details of a character designation determination process

FIG. 47 is a non-limiting example of a flowchart showing the details of a dropping operation determination process;

FIG. 48 is a non-limiting example of a flowchart showing the details of an other-operation determination process;

FIG. 49 is a non-limiting example of a flowchart showing the details of a camera mode change process;

FIG. 50 is a non-limiting example of a flowchart showing the details of a follow mode process;

FIG. 51 is a non-limiting example of a flowchart showing the details of the follow mode process;

FIG. 52 is a non-limiting example of a flowchart showing the details of a cursor display control process;

FIG. 53 is a non-limiting example of a flowchart showing the details of a pinching operation determination process;

FIG. 54 is a non-limiting example of a flowchart showing the details of a virtual camera control process;

FIG. 55 is a non-limiting example of a flowchart showing the details of a mini-skit event process;

FIG. 56 is a non-limiting example of a flowchart showing the details of a dialogue screen process;

FIG. 57 is a non-limiting example of a flowchart showing the details of a list screen process;

FIG. 58 is a non-limiting example of a flowchart showing the details of the list screen process;

FIG. 59 illustrates a modification;

FIG. 60 illustrates the modification;

FIG. 61 illustrates the modification; and

FIG. 62 illustrates the modification.

### DETAILED DESCRIPTION OF NON-LIMITING EXAMPLE EMBODIMENTS

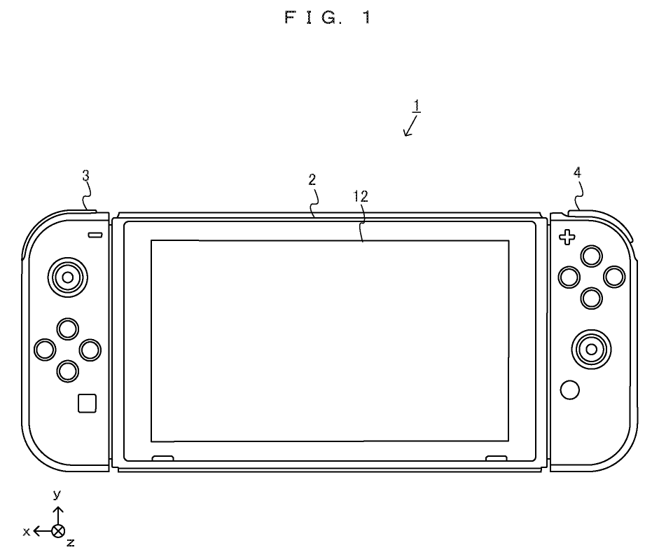

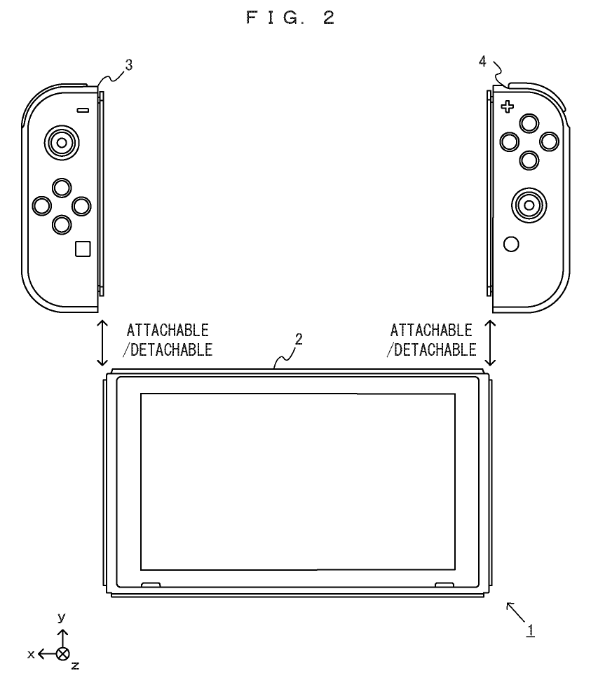

Hereinafter, an exemplary embodiment will be described. FIG. 1 shows an example of the appearance of a game system which is an example of an information processing system. An example of a game system 1 according to the exemplary embodiment includes a main body apparatus (an information processing apparatus, which functions as a game apparatus main body in the exemplary embodiment) 2 which is an example of a computer, a left controller 3, and a right controller 4. Each of the left controller 3 and the right controller 4 is attachable to and detachable from the main body apparatus 2. That is, the game system 1 can be used as a unified apparatus obtained by attaching each of the left controller 3 and the right controller 4 to the main body apparatus 2. Further, in the game system 1, the main body apparatus 2, the left controller 3, and the right controller 4 can also be used as separate bodies (see FIG. 2). Hereinafter, first, the hardware configuration of the game system 1 according to the exemplary embodiment will be described, and then, the control of the game system 1 according to the exemplary embodiment will be described.

FIG. 1 shows an example of the state where the left controller 3 and the right controller 4 are attached to the main body apparatus 2. As shown in FIG. 1, each of the left controller 3 and the right controller 4 is attached to and unified with the main body apparatus 2. The main body apparatus 2 is an apparatus for performing various processes (e.g., game processing) in the game system 1. The main body apparatus 2 includes a display 12. Each of the left controller 3 and the right controller 4 is an apparatus including operation sections with which a player provides inputs.

FIG. 2 shows an example of the state where each of the left controller 3 and the right controller 4 is detached from the main body apparatus 2. As shown in FIGS. 1 and 2, the left controller 3 and the right controller 4 are attachable to and detachable from the main body apparatus 2. Hereinafter, the left controller 3 and the right controller 4 may be collectively referred to as “controller”.

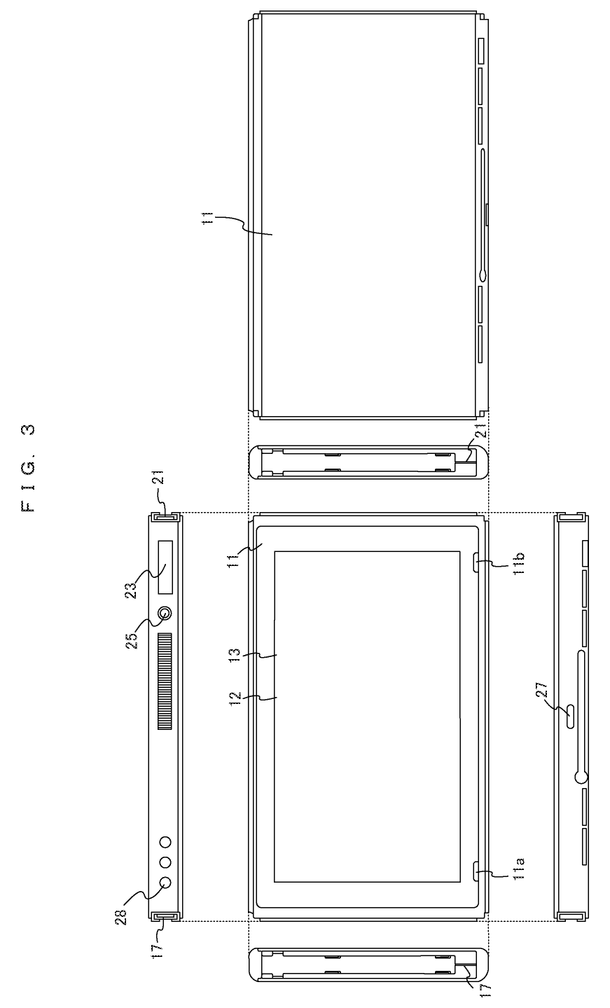

FIG. 3 is six orthogonal views showing an example of the main body apparatus 2. As shown in FIG. 3, the main body apparatus 2 includes an approximately plate-shaped housing 11. In the exemplary embodiment, a main surface (in other words, a surface on a front side, i.e., a surface on which the display 12 is provided) of the housing 11 has a substantially rectangular shape.

The shape and the size of the housing 11 are discretionary. As an example, the housing 11 may be of a portable size. Further, the main body apparatus 2 alone or the unified apparatus obtained by attaching the left controller 3 and the right controller 4 to the main body apparatus 2 may function as a mobile apparatus. The main body apparatus 2 or the unified apparatus may function as a handheld apparatus or a portable apparatus.

As shown in FIG. 3, the main body apparatus 2 includes the display 12, which is provided on the main surface of the housing 11. The display 12 displays an image generated by the main body apparatus 2. In the exemplary embodiment, the display 12 is a liquid crystal display device (LCD). The display 12, however, may be a display device of any type.

The main body apparatus 2 includes a touch panel 13 on the screen of the display 12. In the exemplary embodiment, the touch panel 13 is of a type capable of receiving a multi-touch input (e.g., electrical capacitance type). However, the touch panel 13 may be of any type, and may be, for example, of a type capable of receiving a single-touch input (e.g., resistive film type).

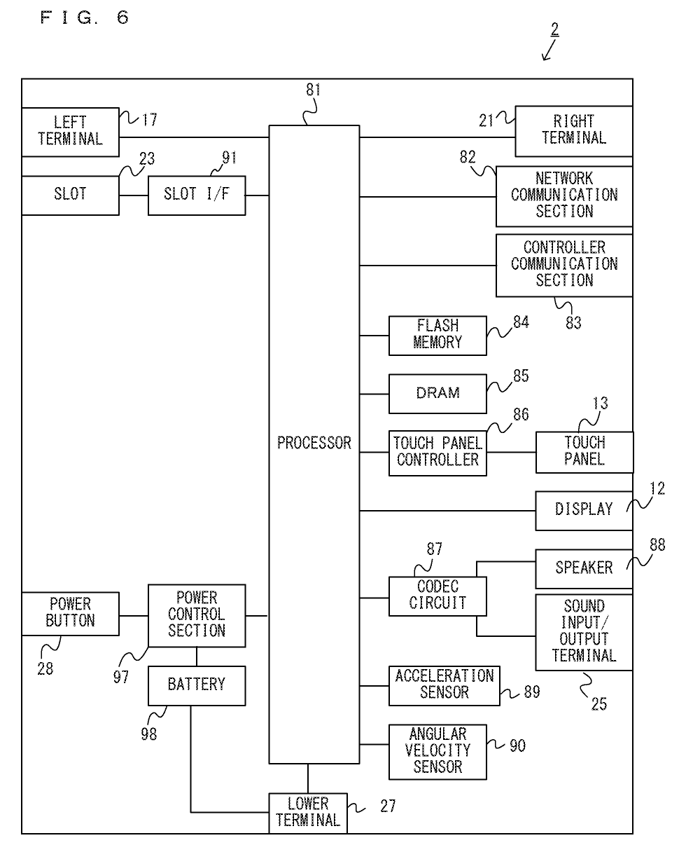

The main body apparatus 2 includes speakers (i.e., speakers 88 shown in FIG. 6) within the housing 11. As shown in FIG. 3, speaker holes 11a and 11b are formed in the main surface of the housing 11. Then, sounds outputted from the speakers 88 are outputted through the speaker holes 11a and 11b.

Further, the main body apparatus 2 includes a left terminal 17, which is a terminal for the main body apparatus 2 to perform wired communication with the left controller 3, and a right terminal 21, which is a terminal for the main body apparatus 2 to perform wired communication with the right controller 4.

As shown in FIG. 3, the main body apparatus 2 includes a slot 23. The slot 23 is provided at an upper side surface of the housing 11. The slot 23 is so shaped as to allow a predetermined type of storage medium to be attached to the slot 23. The predetermined type of storage medium is, for example, a dedicated storage medium (e.g., a dedicated memory card) for the game system 1 and an information processing apparatus of the same type as the game system 1. The predetermined type of storage medium is used to store, for example, data (e.g., saved data of an application or the like) used by the main body apparatus 2 and/or a program (e.g., a program for an application or the like) executed by the main body apparatus 2. Further, the main body apparatus 2 includes a power button 28.

The main body apparatus 2 includes a lower terminal 27. The lower terminal 27 is a terminal for the main body apparatus 2 to communicate with a cradle. In the exemplary embodiment, the lower terminal 27 is a USB connector (more specifically, a female connector). Further, when the unified apparatus or the main body apparatus 2 alone is mounted on the cradle, the game system 1 can display on a stationary monitor an image generated by and outputted from the main body apparatus 2. Further, in the exemplary embodiment, the cradle has the function of charging the unified apparatus or the main body apparatus 2 alone mounted on the cradle. Further, the cradle has the function of a hub device (specifically, a USB hub).

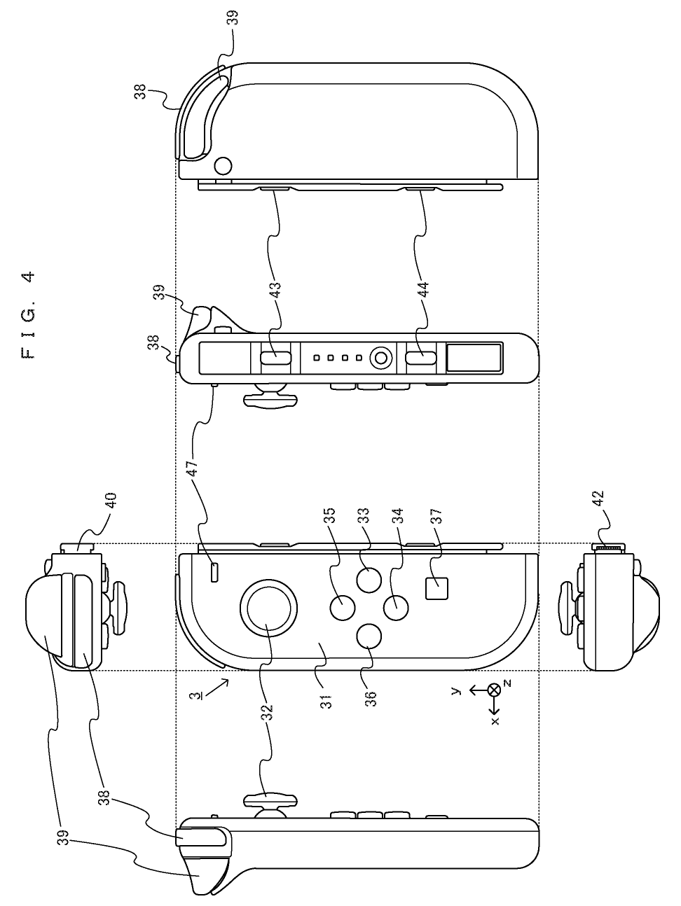

FIG. 4 is six orthogonal views showing an example of the left controller 3. As shown in FIG. 4, the left controller 3 includes a housing 31. In the exemplary embodiment, the housing 31 has a vertically long shape, i.e., is shaped to be long in an up-down direction shown in FIG. 4 (i.e., a y-axis direction shown in FIG. 4). In the state where the left controller 3 is detached from the main body apparatus 2, the left controller 3 can also be held in the orientation in which the left controller 3 is vertically long. The housing 31 has such a shape and a size that when held in the orientation in which the housing 31 is vertically long, the housing 31 can be held with one hand, particularly, the left hand. Further, the left controller 3 can also be held in the orientation in which the left controller 3 is horizontally long. When held in the orientation in which the left controller 3 is horizontally long, the left controller 3 may be held with both hands.

The left controller 3 includes a left analog stick (hereinafter, referred to as a “left stick”) 32 as an example of a direction input device. As shown in FIG. 4, the left stick 32 is provided on a main surface of the housing 31. The left stick 32 can be used as a direction input section with which a direction can be inputted. The player tilts the left stick 32 and thereby can input a direction corresponding to the direction of the tilt (and input a magnitude corresponding to the angle of the tilt). The left controller 3 may include a directional pad, a slide stick that allows a slide input, or the like as the direction input section, instead of the analog stick. Further, in the exemplary embodiment, it is possible to provide an input by pressing the left stick 32.

The left controller 3 includes various operation buttons. The left controller 3 includes four operation buttons 33 to 36 (specifically, a right direction button 33, a down direction button 34, an up direction button 35, and a left direction button 36) on the main surface of the housing 31. Further, the left controller 3 includes a record button 37 and a “−” (minus) button 47. The left controller 3 includes a first L-button 38 and a ZL-button 39 in an upper left portion of a side surface of the housing 31. Further, the left controller 3 includes a second L-button 43 and a second R-button 44, on the side surface of the housing 31 on which the left controller 3 is attached to the main body apparatus 2. These operation buttons are used to give instructions depending on various programs (e.g., an OS program and an application program) executed by the main body apparatus 2.

Further, the left controller 3 includes a terminal 42 for the left controller 3 to perform wired communication with the main body apparatus 2.

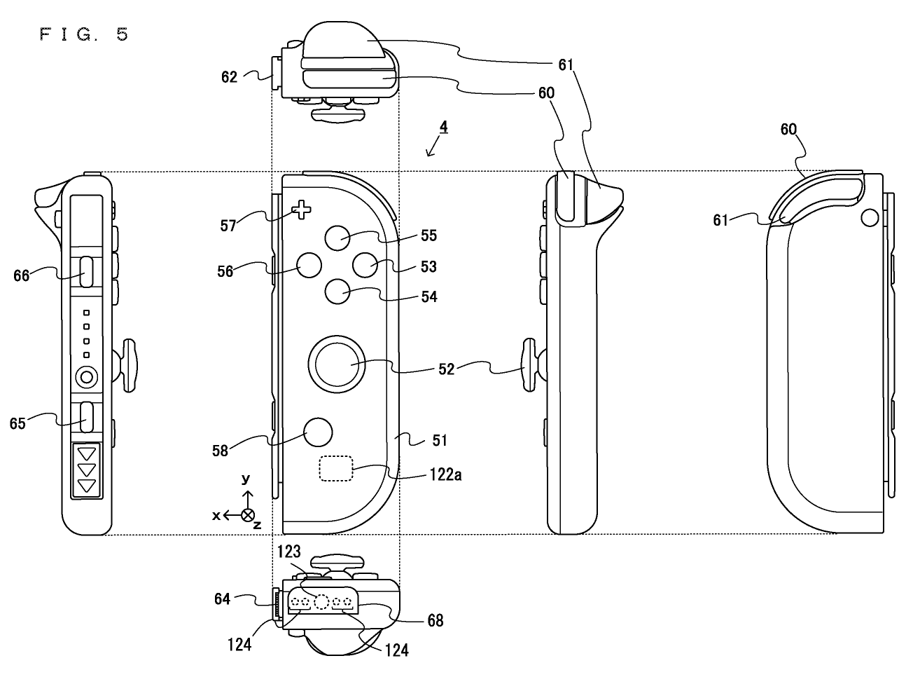

FIG. 5 is six orthogonal views showing an example of the right controller 4. As shown in FIG. 5, the right controller 4 includes a housing 51. In the exemplary embodiment, the housing 51 has a vertically long shape, i.e., is shaped to be long in the up-down direction shown in FIG. 5 (i.e., the y-axis direction shown in FIG. 5). In the state where the right controller 4 is detached from the main body apparatus 2, the right controller 4 can also be held in the orientation in which the right controller 4 is vertically long. The housing 51 has such a shape and a size that when held in the orientation in which the housing 51 is vertically long, the housing 51 can be held with one hand, particularly the right hand. Further, the right controller 4 can also be held in the orientation in which the right controller 4 is horizontally long. When held in the orientation in which the right controller 4 is horizontally long, the right controller 4 may be held with both hands.

Similarly to the left controller 3, the right controller 4 includes a right analog stick (hereinafter, referred to as a “right stick”) 52 as a direction input section. In the exemplary embodiment, the right stick 52 has the same configuration as that of the left stick 32 of the left controller 3. Further, the right controller 4 may include a directional pad, a slide stick that allows a slide input, or the like, instead of the analog stick. Further, similarly to the left controller 3, the right controller 4 includes four operation buttons 53 to 56 (specifically, an A-button 53, a B-button 54, an X-button 55, and a Y-button 56) on a main surface of the housing 51. Further, the right controller 4 includes a “+” (plus) button 57 and a home button 58. Further, the right controller 4 includes a first R-button 60 and a ZR-button 61 in an upper right portion of a side surface of the housing 51. Further, similarly to the left controller 3, the right controller 4 includes a second L-button 65 and a second R-button 66.

Further, the right controller 4 includes a terminal 64 for the right controller 4 to perform wired communication with the main body apparatus 2.

FIG. 6 is a block diagram showing an example of the internal configuration of the main body apparatus 2. The main body apparatus 2 includes components 81 to 91, 97, and 98 shown in FIG. 6 in addition to the components shown in FIG. 3. Some of the components 81 to 91, 97, and 98 may be mounted as electronic components on an electronic circuit board and housed in the housing 11.

The main body apparatus 2 includes a processor 81. The processor 81 is an information processing section for executing various types of information processing to be executed by the main body apparatus 2. For example, the processor 81 may be composed only of a CPU (Central Processing Unit), or may be composed of a SoC (System-on-a-chip) having a plurality of functions such as a CPU function and a GPU (Graphics Processing Unit) function. The processor 81 executes an information processing program (e.g., a game program) stored in a storage section (specifically, an internal storage medium such as a flash memory 84, an external storage medium attached to the slot 23, or the like), thereby performing the various types of information processing.

The main body apparatus 2 includes the flash memory 84 and a DRAM (Dynamic Random Access Memory) 85 as examples of internal storage media built into the main body apparatus 2. The flash memory 84 and the DRAM 85 are connected to the processor 81. The flash memory 84 is a memory mainly used to store various data (or programs) to be saved in the main body apparatus 2. The DRAM 85 is a memory used to temporarily store various data used for information processing. The processor 31 appropriately reads and writes data from and to the storage media such as the flash memory 84 and the DRAM 85 to execute various types of information processing. In the exemplary embodiment, the “memory” may include at least a flash memory and a DRAM and may also include other storage media.

The main body apparatus 2 includes a slot interface (hereinafter, abbreviated as “I/F”) 91. The slot I/F 91 is connected to the processor 81. The slot I/F 91 is connected to the slot 23, and in accordance with an instruction from the processor 81, reads and writes data from and to the predetermined type of storage medium (e.g., a dedicated memory card) attached to the slot 23.

The processor 81 appropriately reads and writes data from and to the flash memory 84, the DRAM 85, and each of the above storage media, thereby performing the above information processing.

The main body apparatus 2 includes a network communication section 82. The network communication section 82 is connected to the processor 81. The network communication section 82 communicates (specifically, through wireless communication) with an external apparatus via a network. In the exemplary embodiment, as a first communication form, the network communication section 82 connects to a wireless LAN and communicates with an external apparatus, using a method compliant with the Wi-Fi standard. Further, as a second communication form, the network communication section 82 wirelessly communicates with another main body apparatus 2 of the same type, using a predetermined method for communication (e.g., communication based on a unique protocol or infrared light communication). The wireless communication in the above second communication form achieves the function of enabling so-called “local communication” in which the main body apparatus 2 can wirelessly communicate with another main body apparatus 2 placed in a closed local network area, and the plurality of main body apparatuses 2 directly communicate with each other to transmit and receive data.

The main body apparatus 2 includes a controller communication section 83. The controller communication section 83 is connected to the processor 81. The controller communication section 83 wirelessly communicates with the left controller 3 and/or the right controller 4. The communication method between the main body apparatus 2, and the left controller 3 and the right controller 4, is discretionary. In the exemplary embodiment, the controller communication section 83 performs communication compliant with the Bluetooth (registered trademark) standard with the left controller 3 and with the right controller 4.

The processor 81 is connected to the left terminal 17, the right terminal 21, and the lower terminal 27. When performing wired communication with the left controller 3, the processor 81 transmits data to the left controller 3 via the left terminal 17 and also receives operation data from the left controller 3 via the left terminal 17. Further, when performing wired communication with the right controller 4, the processor 81 transmits data to the right controller 4 via the right terminal 21 and also receives operation data from the right controller 4 via the right terminal 21. Further, when communicating with the cradle, the processor 81 transmits data to the cradle via the lower terminal 27. As described above, in the exemplary embodiment, the main body apparatus 2 can perform both wired communication and wireless communication with each of the left controller 3 and the right controller 4. Further, when the unified apparatus obtained by attaching the left controller 3 and the right controller 4 to the main body apparatus 2 or the main body apparatus 2 alone is attached to the cradle, the main body apparatus 2 can output data (e.g., image data or sound data) to the stationary monitor or the like via the cradle.

Here, the main body apparatus 2 can communicate with a plurality of left controllers 3 simultaneously (in other words, in parallel). Further, the main body apparatus 2 can communicate with a plurality of right controllers 4 simultaneously (in other words, in parallel). Thus, a plurality of players can simultaneously provide inputs to the main body apparatus 2, each using a set of the left controller 3 and the right controller 4. As an example, a first player can provide an input to the main body apparatus 2 using a first set of the left controller 3 and the right controller 4, and simultaneously, a second player can provide an input to the main body apparatus 2 using a second set of the left controller 3 and the right controller 4.

The main body apparatus 2 includes a touch panel controller 86, which is a circuit for controlling the touch panel 13. The touch panel controller 86 is connected between the touch panel 13 and the processor 81. On the basis of a signal from the touch panel 13, the touch panel controller 86 generates data indicating the position at which a touch input has been performed, for example, and outputs the data to the processor 81.

Further, the display 12 is connected to the processor 81. The processor 81 displays a generated image (e.g., an image generated by executing the above information processing) and/or an externally acquired image on the display 12.

The main body apparatus 2 includes a codec circuit 87 and speakers (specifically, a left speaker and a right speaker) 88. The codec circuit 87 is connected to the speakers 88 and a sound input/output terminal 25 and also connected to the processor 81. The codec circuit 87 is a circuit for controlling the input and output of sound data to and from the speakers 88 and the sound input/output terminal 25.

The main body apparatus 2 includes a power control section 97 and a battery 98. The power control section 97 is connected to the battery 98 and the processor 81. Further, although not shown in FIG. 6, the power control section 97 is connected to components of the main body apparatus 2 (specifically, components that receive power supplied from the battery 98, the left terminal 17, and the right terminal 21). On the basis of a command from the processor 81, the power control section 97 controls the supply of power from the battery 98 to the above components.

Further, the battery 98 is connected to the lower terminal 27. When an external charging device (e.g., the cradle) is connected to the lower terminal 27 and power is supplied to the main body apparatus 2 via the lower terminal 27, the battery 98 is charged with the supplied power.

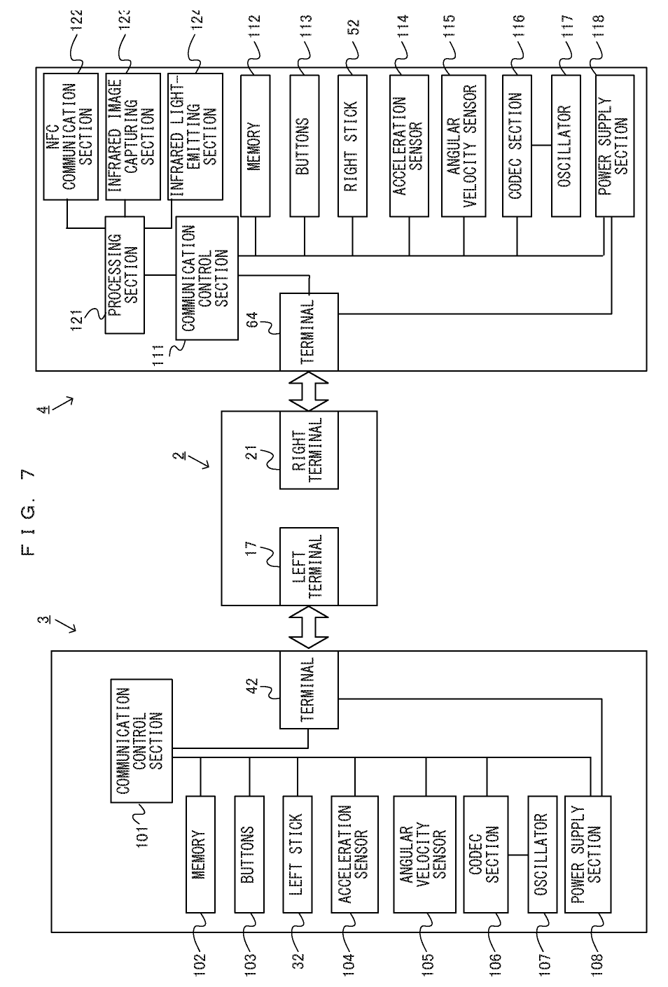

FIG. 7 is a block diagram showing examples of the internal configurations of the main body apparatus 2, the left controller 3, and the right controller 4. The details of the internal configuration of the main body apparatus 2 are shown in FIG. 6 and therefore are omitted in FIG. 7.

The left controller 3 includes a communication control section 101, which communicates with the main body apparatus 2. As shown in FIG. 7, the communication control section 101 is connected to components including the terminal 42. In the exemplary embodiment, the communication control section 101 can communicate with the main body apparatus 2 through both wired communication via the terminal 42 and wireless communication not via the terminal 42. The communication control section 101 controls the method for communication performed by the left controller 3 with the main body apparatus 2. That is, when the left controller 3 is attached to the main body apparatus 2, the communication control section 101 communicates with the main body apparatus 2 via the terminal 42. Further, when the left controller 3 is detached from the main body apparatus 2, the communication control section 101 wirelessly communicates with the main body apparatus 2 (specifically, the controller communication section 83). The wireless communication between the communication control section 101 and the controller communication section 83 is performed in accordance with the Bluetooth (registered trademark) standard, for example.

Further, the left controller 3 includes a memory 102 such as a flash memory. The communication control section 101 includes, for example, a microcomputer (or a microprocessor) and executes firmware stored in the memory 102, thereby performing various processes.

The left controller 3 includes buttons 103 (specifically, the buttons 33 to 39, 43, 44, and 47). Further, the left controller 3 includes the left stick 32. Each of the buttons 103 and the left stick 32 outputs information regarding an operation performed on itself to the communication control section 101 repeatedly at appropriate timings.

The left controller 3 includes inertial sensors. Specifically, the left controller 3 includes an acceleration sensor 104. Further, the left controller 3 includes an angular velocity sensor 105. In the exemplary embodiment, the acceleration sensor 104 detects the magnitudes of accelerations along predetermined three axial (e.g., x, y, z axes shown in FIG. 4) directions. The acceleration sensor 104 may detect an acceleration along one axial direction or accelerations along two axial directions. In the exemplary embodiment, the angular velocity sensor 105 detects angular velocities about predetermined three axes (e.g., the x, y, z axes shown in FIG. 4). The angular velocity sensor 105 may detect an angular velocity about one axis or angular velocities about two axes. Each of the acceleration sensor 104 and the angular velocity sensor 105 is connected to the communication control section 101. Then, the detection results of the acceleration sensor 104 and the angular velocity sensor 105 are outputted to the communication control section 101 repeatedly at appropriate timings.

The communication control section 101 acquires information regarding an input (specifically, information regarding an operation or the detection result of the sensor) from each of input sections (specifically, the buttons 103, the left stick 32, and the sensors 104 and 105). The communication control section 101 transmits operation data including the acquired information (or information obtained by performing predetermined processing on the acquired information) to the main body apparatus 2. The operation data is transmitted repeatedly, once every predetermined time. The interval at which the information regarding an input is transmitted from each of the input sections to the main body apparatus 2 may or may not be the same.

The above operation data is transmitted to the main body apparatus 2, whereby the main body apparatus 2 can obtain inputs provided to the left controller 3. That is, the main body apparatus 2 can determine operations on the buttons 103 and the left stick 32 on the basis of the operation data. Further, the main body apparatus 2 can calculate information regarding the motion and/or the orientation of the left controller 3 on the basis of the operation data (specifically, the detection results of the acceleration sensor 104 and the angular velocity sensor 105).

The left controller 3 includes a vibrator 107 for notifying a user by vibration. In the exemplary embodiment, the vibrator 107 is controlled by a command from the main body apparatus 2. That is, when the communication control section 101 receives the above command from the main body apparatus 2, the communication control section 101 drives the vibrator 107 according to this command. Here, the left controller 3 includes a codec section 106. When the communication control section 101 receives the above command, the communication control section 101 outputs a control signal corresponding to the command, to the codec section 106. The codec section 106 generates a drive signal for driving the vibrator 107 from the control signal from the communication control section 101 and provides the drive signal to the vibrator 107. Accordingly, the vibrator 107 operates.

The vibrator 107 is more specifically a linear vibration motor. Unlike a normal motor that performs rotational motion, the linear vibration motor is driven in a predetermined direction according to an inputted voltage and thus can be vibrated at an amplitude and a frequency corresponding to the waveform of the inputted voltage. In the exemplary embodiment, the vibration control signal transmitted from the main body apparatus 2 to the left controller 3 may be a digital signal representing the frequency and the amplitude per unit time. In another exemplary embodiment, information indicating the waveform itself may be transmitted from the main body apparatus 2, but by transmitting only the amplitude and the frequency, the amount of communication data can be reduced. In addition, in order to further reduce the amount of data, only the differences from the previous values may be transmitted instead of the values of the amplitude and the frequency at that time. In this case, the codec section 106 converts the digital signal indicating the amplitude and frequency values acquired from the communication control section 101 into an analog voltage waveform and drives the vibrator 107 by inputting a voltage in accordance with this waveform. Therefore, the main body apparatus 2 can control the amplitude and the frequency for vibrating the vibrator 107 at that time, by changing the amplitude and the frequency transmitted per unit time. Each of the amplitude and the frequency transmitted from the main body apparatus 2 to the left controller 3 is not limited to one, and two or more amplitudes and two or more frequencies may be transmitted. In that case, the codec section 106 can generate a waveform of the voltage for controlling the vibrator 107 by synthesizing the waveforms that are indicated by the received multiple amplitudes and frequencies, respectively.

The left controller 3 includes a power supply section 108. In the exemplary embodiment, the power supply section 108 includes a battery and a power control circuit. Although not shown in FIG. 7, the power control circuit is connected to the battery and also connected to components of the left controller 3 (specifically, components that receive power supplied from the battery).

As shown in FIG. 7, the right controller 4 includes a communication control section 111, which communicates with the main body apparatus 2. Further, the right controller 4 includes a memory 112, which is connected to the communication control section 111. The communication control section 111 is connected to components including the terminal 64. The communication control section 111 and the memory 112 have functions similar to those of the communication control section 101 and the memory 102, respectively, of the left controller 3. Thus, the communication control section 111 can communicate with the main body apparatus 2 through both wired communication via the terminal 64 and wireless communication not via the terminal 64 (specifically, communication compliant with the Bluetooth (registered trademark) standard). The communication control section 111 controls the method for communication performed by the right controller 4 with the main body apparatus 2.

The right controller 4 includes input sections similar to the input sections of the left controller 3. Specifically, the right controller 4 includes buttons 113, the right stick 52, and inertial sensors (an acceleration sensor 114 and an angular velocity sensor 115). These input sections have functions similar to those of the input sections of the left controller 3 and operate similarly to the input sections of the left controller 3.

The right controller 4 also includes a vibrator 117 and a codec section 116. The vibrator 117 and the codec section 116 operate in the same manner as the vibrator 107 and the codec section 106 of the left controller 3. That is, the communication control section 111 operates the vibrator 117, using the codec section 116, according to a command from the main body apparatus 2.

The right controller 4 includes a power supply section 118. The power supply section 118 has a function similar to that of the power supply section 108 of the left controller 3 and operates similarly to the power supply section 108.

### Outline of game processing in exemplary embodiment

Next, the outline of operation of game processing executed by the game system 1 according to the exemplary embodiment will be described. In the following description, the left controller 3 and the right controller 4 are collectively referred to simply as “controller”.

### Assumed game

Next, a game assumed in the exemplary embodiment will be described. In the game assumed in the exemplary embodiment, the user can freely place various objects within a three‑dimensional virtual space (hereinafter simply referred to as virtual space) to create a virtual town space (hereinafter referred to as virtual town). In this example, a virtual “island” is prepared within the virtual space, and the user can create the virtual town on this island. Examples of objects that can be placed include building‑type objects (hereinafter simply referred to as building) and decoration‑type objects (hereinafter referred to as decorations). Examples of buildings include detached houses, apartment buildings, and shops. Examples of decorations include roads, street trees, potted plants, streetlights, and traffic signals. By performing predetermined operations on a predetermined edit screen, the user can place these objects at desired positions on the island.

Furthermore, in this game, the user can create virtual residents, which are virtual character objects, and place the virtual residents within the above virtual town. The appearance of each virtual resident can also be created and edited by the user. Each placed virtual resident acts autonomously and leads a virtual life. That is, the user can create virtual residents and allow the virtual residents to live in the virtual town.

This game is a game in which the user creates a virtual town, places virtual residents within the virtual town, and observes how each virtual resident lives within the virtual town.

### Human relationship parameter

Here, each virtual resident is provided with a parameter referred to as a “human relationship parameter”, and virtual human relationships are constructed among the virtual residents. In other words, each human relationship parameter is a parameter regarding a “combination” of one virtual resident and another virtual resident. In this example, the human relationship parameters include parameters of “current relationship” and “affection level”. The “current relationship” is a parameter indicating the current relationship with a certain virtual resident. Specifically, examples thereof include “stranger”, “acquaintance”, “friend”, “romantic partner”, “married couple”, and “parent-child”. The “affection level” indicates the degree of affection toward another virtual resident. When this value changes, the “current relationship” may also change. For example, for virtual residents between which the “current relationship” is “acquaintance”, when the mutual “affection level” of these virtual residents reaches a threshold value (e.g., 100), the “current relationship” therebetween is updated to “friend”, and the mutual “affection level” is reset to 50. In this game, a higher affection level makes it easier for residents to develop closer relationships. Even when the “affection level” has reached the threshold value, the “current relationship” does not have to be updated unless a predetermined event (such as a specific mini-skit event) occurs.

A “feeling” toward another virtual resident is determined based on a combination of the “current relationship” and the “affection level”. For example, when the “current relationship” with a certain virtual resident is “friend” and the “affection level” is 50, “fun” is displayed as the “feeling” toward the virtual resident, and when the “current relationship” is “acquaintance” and the “affection level” is 50, “might get along well” or the like is displayed. When the “current relationship” is “friend” and the “affection level” is 20, “slightly dissatisfied” or the like is expressed. In addition to the above, a parameter indicating a temporarily given special state such as “unrequited love” or “in the middle of a quarrel” may be included as a human relationship parameter.

The ease with which the affection level increases may vary depending on the current relationship. For example, the affection level toward a virtual resident whose “current relationship” is “acquaintance” may increase more easily than toward a virtual resident whose “current relationship” is “friend”, or vice versa.

In addition to the “human relationship parameter”, a “mood parameter” is also set for each virtual resident. This parameter indicates the current “mood” of the virtual resident. For example, the mood parameter may be indicated by a numerical value within a predetermined range, with lower values indicating negative mood states and higher values indicating positive mood states. Examples of negative mood states include “feeling down”, “irritated”, and “angry”. Examples of positive mood states include “cheerful” and “full of happiness”. Additionally, examples of a mood state indicated by an intermediate value include “normal”.

Based on the human relationship parameter described above, in‑game events (hereinafter simply referred to as “events”) may occur between virtual residents. Specifically, conversation events and mini-skit events, which will be described later, may occur. Along with the occurrence of these events, the above human relationship parameters and mood parameters may change. In this game, a change in the human relationship parameter in the case of a mini-skit event is basically a change that increases the affection level. That is, such a change is to change the affection level to develop a closer relationship. As a result of the increased affection level, the “current relationship” may change, for example, from “friend” to “romantic partner”.

As the affection level between virtual residents increases, the number of types of events that can occur between these virtual residents also increases. For example, only two types of events may occur between virtual residents who are “strangers” to each other, whereas five types of events may occur between virtual residents who have become “friends”. That is, when virtual residents become closer to each other, the number of types of events that can occur therebetween increases, so that it is possible to provide the user with motivation to make virtual residents become closer to each other.

As for changes in human relationship parameters, in addition to the changes caused by the above events, for example, when the game is launched, the affection level may be randomly increased or decreased based on the elapsed time from the end of the previous game.

FIG. 8 shows a screen example of this game. FIG. 8 illustrates a game screen based on an overhead viewpoint as if looking down on the virtual town from above. Within the game screen, a finger‑shaped cursor and multiple virtual residents are displayed. The finger‑shaped cursor also serves as a substantial object to be operated by the user. To describe this point more precisely, in this game, an invisible point referred to as a “reference point” is provided, and the object to be operated directly by the user is this reference point. Specifically, the user changes the X‑coordinate and the Z‑coordinate of the reference point in the virtual space by operating the left stick 32. Collision detection may not necessarily be performed, and the reference point may be movable along the ground surface of the virtual town, for example. Alternatively, when a building in the virtual town overlaps the X‑coordinate and the Z‑coordinate of the reference point, the Y‑coordinate of the reference point may be determined such that the reference point is positioned higher than the building. Alternatively, the reference point may be moved on the XZ plane of the virtual space at a predetermined height from the ground surface of the virtual town. In this example, a case where the reference point is moved along the ground surface of the virtual town will be described. The gazing point of the virtual camera and the position of the finger‑shaped cursor are determined individually based on the position of the reference point. In this game, the position of the reference point, the position of the gazing point, and the position of the finger‑shaped cursor are set such that the reference point, the gazing point, and the finger‑shaped cursor are displayed at nearly the same position on the game screen in FIG. 8. That is, control is performed in which the reference point is positioned near the center of the game screen, the gazing point of the virtual camera is also located at the center of the screen, and the finger‑shaped cursor is also displayed at the center of the screen. Therefore, in this game, when the left stick 32 is operated, the virtual camera is moved in a state where the finger‑shaped cursor is always displayed at the center of the game screen, thereby providing the user with an operational feel as if the user was moving the finger‑shaped cursor (user’s viewpoint) in the air above the virtual town.

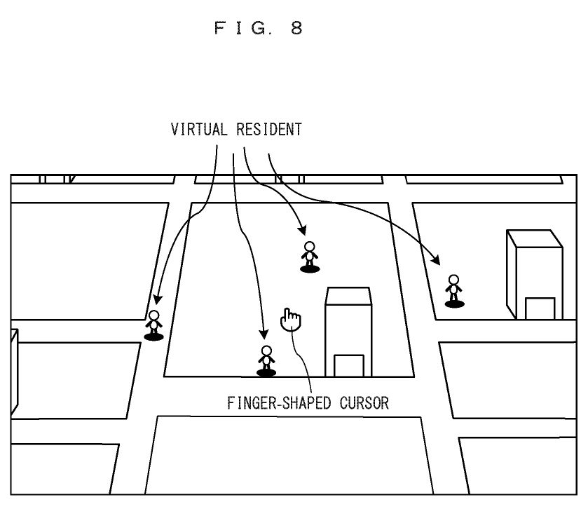

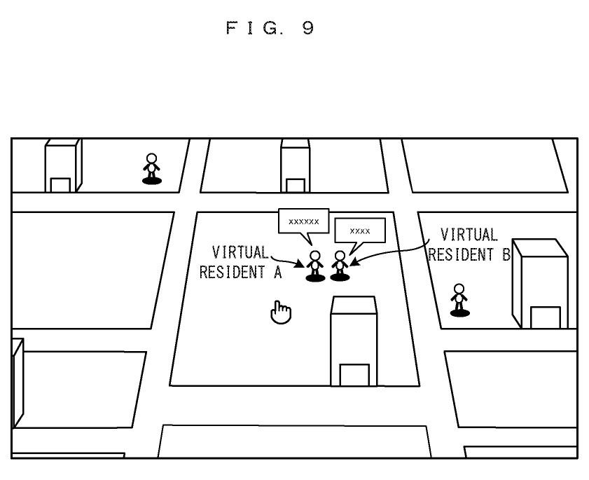

Basically, each virtual resident acts autonomously. Each virtual resident may move to various locations within the virtual town and take various actions. As a result of autonomous actions, “conversation events” may occur between virtual residents. When a conversation event occurs, for example, as shown in FIG. 9, speech bubbles indicating conversation content are displayed, showing that virtual residents are conversing within the virtual town. As a result of such a conversation event, the human relationship parameter between and the mood parameters of the virtual residents who have conversed may change randomly. For example, the affection level between the virtual residents who have conversed increases or decreases. Furthermore, in this game, the virtual residents engaged in the conversation event are temporarily grouped. For example, when a conversation event occurs between a virtual resident A and a virtual resident B, these virtual residents are temporarily grouped. Upon the end of the conversation event, the grouping is released.

Next, operations that can be performed by the user with respect to such a virtual world will be described. This game is basically a game in which the user can observe the lives of virtual residents, and various events (e.g., the conversation event described above) through which human relationship parameters can be changed also occur based on the autonomous actions of virtual residents. That is, the user basically takes a passive stance of “waiting” for such events to occur. However, in this game, the user is also able to perform operations for somewhat actively inducing events between virtual residents. Specifically, the user can perform an operation of “pinching” a virtual resident by using the above finger‑shaped cursor, carry the virtual resident to another virtual resident, and “drop” the virtual resident, thereby attempting to cause an event to occur between these virtual residents. Examples of such operations will be described below using screen examples.

### Pinching operation

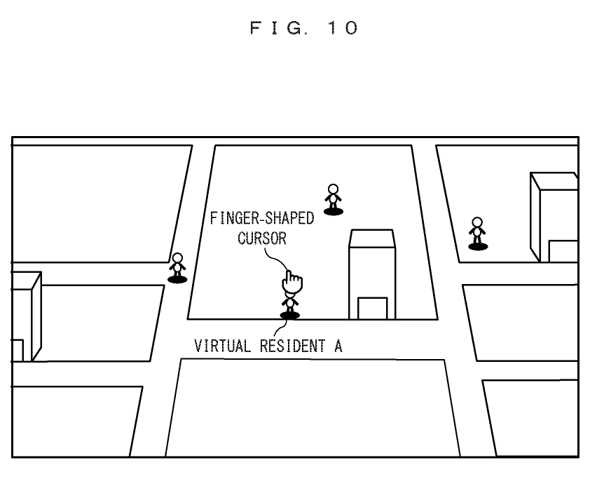

First, as shown in FIG. 10, the user aligns the finger‑shaped cursor with the virtual resident A and performs a long‑press operation on the A-button 53. Then, as shown in FIG. 11, the shape of the finger‑shaped cursor changes slightly, and a state where the virtual resident A is being pinched and lifted is displayed. Hereinafter, this operation is referred to as “pinching operation”. In this case, while being pinched, the virtual resident may perform a motion such as flailing. In the following, as the state of the virtual resident, a state where the virtual resident is being pinched and lifted is sometimes also referred to as “pinched state”, and a state where the virtual resident is not being pinched and lifted is sometimes also referred to as “non‑pinched state”. In addition, the virtual resident in the “pinched state” is sometimes also referred to as “currently pinched character”. Once the virtual resident transitions to the “pinched state”, even if the finger is released from the A-button 53, the pinched state is maintained. In addition, the currently pinched character does not (cannot) act autonomously as described above.

### Movement while pinching

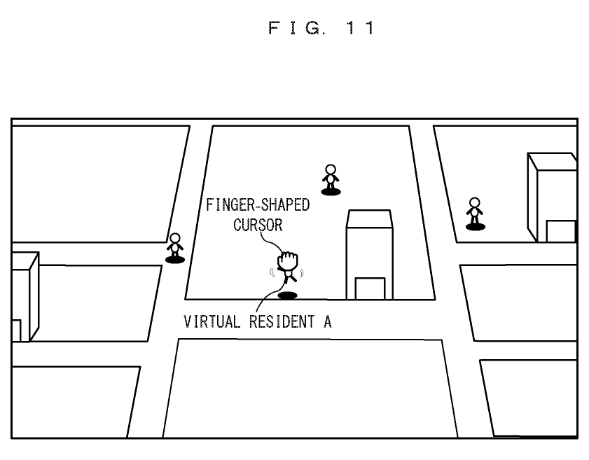

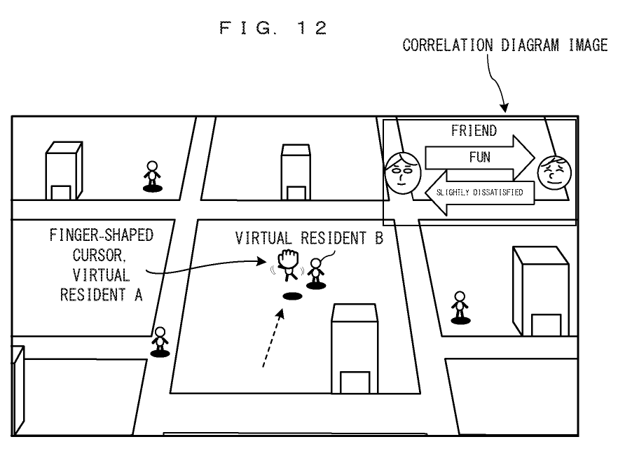

Next, by operating the finger‑shaped cursor with the left stick 32, the user can move the currently pinched character (while pinching the currently pinched character). Then, for example, as shown in FIG. 12, the user moves the currently pinched character (virtual resident A) to a position close to the virtual resident B. At this time, a “correlation diagram image” is displayed as shown in the upper‑right corner of the screen example of FIG. 12 (the display position may be any position). The correlation diagram image is displayed when another virtual resident is within a predetermined range based on the currently pinched character. The predetermined range is, for example, a circular range centered on a position directly below the currently pinched character, as shown in FIG. 13. Hereinafter, this range is referred to as “first correlation display range”.

### Correlation diagram

FIG. 14 shows an enlarged view of the correlation diagram image. The correlation diagram image in FIG. 14 is an image indicating a status of the “human relationship parameter” (hereinafter referred to as “human relationship”) between the currently pinched character and the virtual resident B who is within the first correlation display range. Specifically, the correlation diagram image includes face icons corresponding to the currently pinched character and the virtual resident B. The correlation diagram image also includes a current relationship display indicating the current relationship between these residents (displayed as “friend” in the example of FIG. 14). The correlation diagram image also includes two arrow images: one showing the feeling of the currently pinched character toward the virtual resident B and one showing the feeling of the virtual resident B toward the currently pinched character. In this example, each arrow image is an arrow image including a character string indicating a feeling.

In the following description, as for the correlation diagram image, a virtual resident corresponding to the above currently pinched character is sometimes also referred to as “correlation reference character”, and a virtual resident corresponding to the virtual resident B is sometimes also referred to as “correlation target character”.

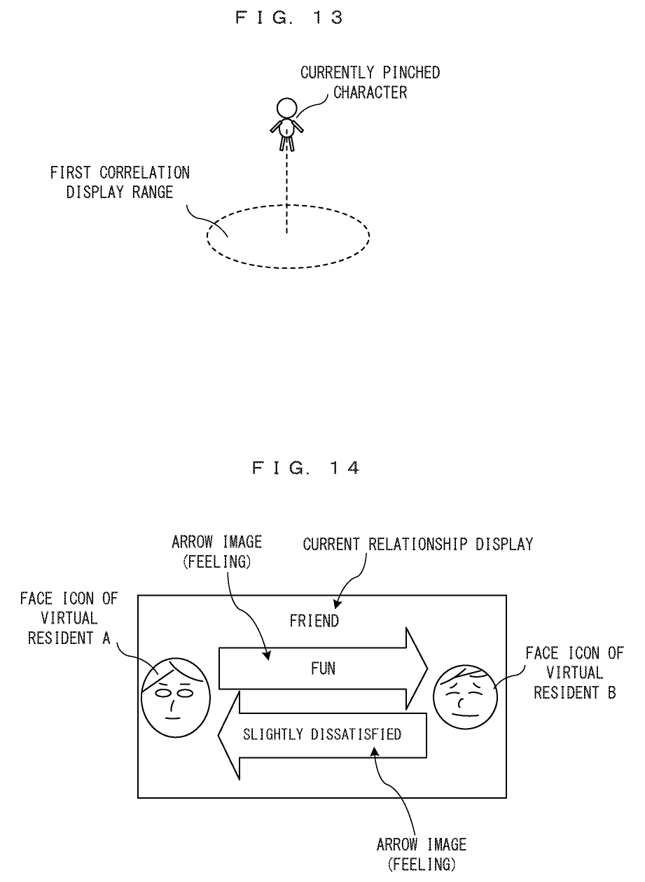

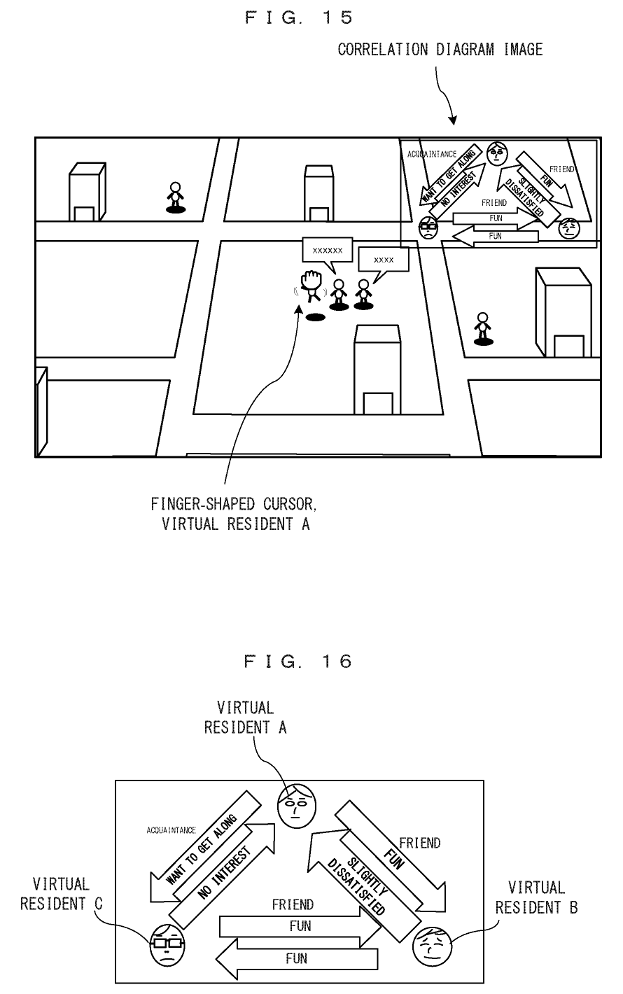

Here, in the example of FIG. 14 above, a one‑to‑one human relationship is indicated, but in the exemplary embodiment, it is also possible to show a human relationship among a plurality of virtual residents in a correlation diagram image. First, when a plurality of other virtual residents exist within the first correlation display range, one virtual resident closest to the correlation reference character becomes a correlation target character, and a one-to-one correlation diagram image is basically displayed. However, when this correlation target character has been “grouped” as described above, a correlation diagram image in which the virtual residents in the group are set as correlation target characters may be displayed. For example, as shown in FIG. 15, when the currently pinched character is moved to a position close to two other virtual residents who are engaged in a conversation event, a correlation diagram image indicating a human relationship with all the virtual residents engaged in the conversation event may be displayed. FIG. 16 is an enlarged view of the correlation diagram image in FIG. 15 above. In FIG. 16, the human relationship is indicated in a configuration in which face icons are arranged at the vertices of a triangle. In the case of a correlation diagram image for three or more virtual residents, as shown in FIG. 16, a human relationship between the correlation target characters (the virtual resident B and a virtual resident C in FIG. 16) is also indicated. Although not shown, when the number of other virtual residents that are grouped is three, a human relationship is indicated in a configuration in which face icons are arranged at the vertices of a quadrilateral, for example.

In this game, the above conversation event for four or more virtual residents is not caused to occur, and the number of virtual residents grouped for a conversation event is limited to a maximum of three. That is, the correlation diagram image is limited to an image for up to four virtual residents.

The elements displayed in the correlation diagram image are not limited to those described above. Other elements indicating the human relationship may be displayed. For example, the correlation diagram image may include an image indicating a specific state such as unrequited love. Conversely, the various elements described above do not have to all be included. For example, the correlation diagram image may include only the face icons and the current relationship display, without including the arrow images.

### Dropping operation

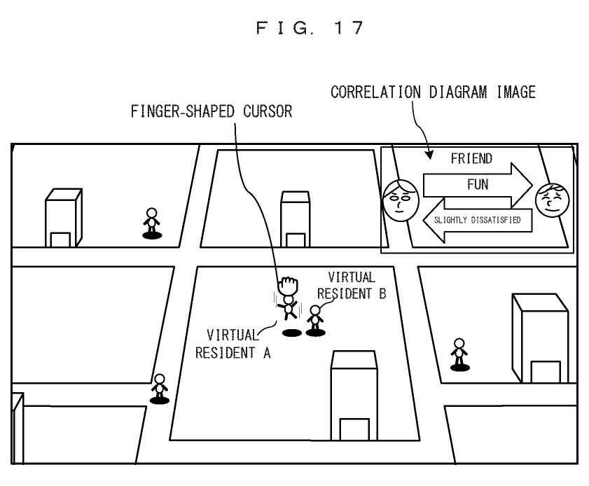

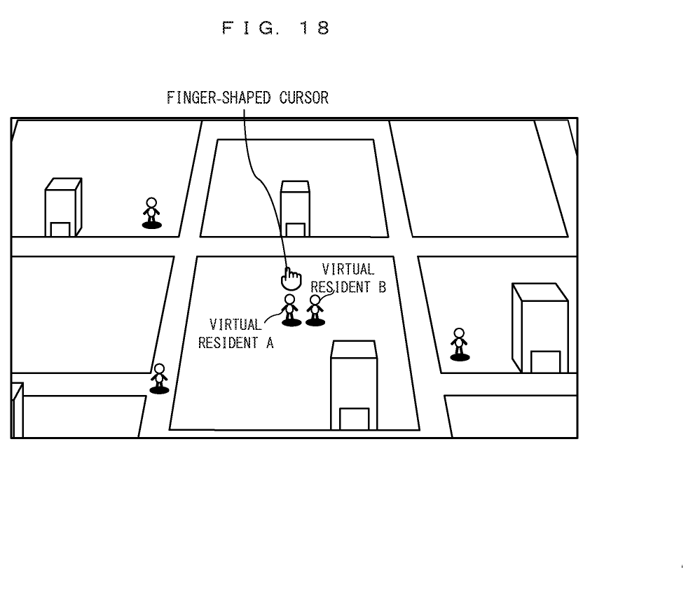

Next, an operation for dropping a currently pinched character will be described. When the user performs a short-press operation on the A-button 53 in a state where there is a currently pinched character, the “pinched state” is released, and, as shown in FIG. 17 and FIG. 18, the currently pinched character (the virtual resident A in the illustrated example) can be dropped directly downward. Hereinafter, this operation is referred to as “dropping operation”. With such a series of operations of pinching a virtual resident, moving the virtual resident, and dropping the virtual resident, the user can move a predetermined virtual resident to any position within the virtual town. In addition, whenever another virtual resident is located near the “currently pinched character” during this process, the correlation diagram image described above may be displayed. Moreover, such a series of operations can be regarded as an operation for eventually bringing the virtual resident A to meet the virtual resident B.

Furthermore, in this game, when an operation of pinching and moving a predetermined virtual resident and dropping the virtual resident in a state where a correlation diagram image with another virtual resident is displayed, is performed as described above, a “mini-skit event”, a “conversation event”, or the like through which the human relationship parameter between the currently pinched character and the other virtual resident is changed, may occur. In this example, as a condition for a mini-skit event to occur, the case where the currently pinched character is dropped in a state where the correlation diagram image is displayed is used. In another exemplary embodiment, the condition may be a condition that “as a result of the currently pinched character being dropped onto the ground, the distance between the currently pinched character and another virtual resident is less than a predetermined distance”.

In this game, when it is possible for a mini-skit event to occur, control is also performed such that, when the currently pinched character approaches another virtual resident as shown in FIG. 12 above, the line of sight of the other virtual resident (the virtual resident B in FIG. 12) is directed toward the currently pinched character. That is, another virtual resident for which it is possible for a mini-skit event to occur performs the behavior of looking up at the currently pinched character.

### Mini-skit event

Next, the mini-skit event will be described. FIG. 19 shows an example of a game screen when the above mini-skit event occurs. The mini-skit event is an event showing a mini-skit between virtual residents. The mini-skit event is shown, for example, by reproducing a movie‑like scene. Examples of the content of the mini-skit include exchanging gifts and helping a virtual resident who has fallen and cannot move. When the mini-skit event begins, the scene switches to a close‑up display of the virtual resident A and the virtual resident B as shown in FIG. 19, and the mini-skit event is reproduced by displaying conversation content using speech bubbles and by the respective virtual residents performing predetermined actions. Then, when the mini-skit event ends, the screen returns to the game screen shown in FIG. 18. While the mini-skit event is displayed, the flow of time within the virtual town is temporarily halted.

Along with the occurrence of such a mini-skit event, the human relationship parameter of the virtual residents may change. In the above example, the mini-skit event occurs between the virtual resident A and the virtual resident B, and the human relationship parameter and the mood parameters of these virtual residents may change. Depending on the content of the mini-skit event, satisfying a predetermined condition may be required as a condition for changing the human relationship parameter, etc. For example, the current relationship is changed on a condition that the affection level reaches a predetermined value or more as described above. More specifically, when the dropping operation is performed as described above and the mini-skit event occurs, if the mutual affection level of the virtual resident A and the virtual resident B whose current relationship is “acquaintance” is equal to or greater than a certain value, the affection level further increases, and the current relationship changes to “friend” (the event is determined as successful). On the other hand, if the mutual affection level has not reached the certain value, the affection level may increase, but the current relationship remains unchanged as “acquaintance” (the event is determined as unsuccessful).

When the human relationship parameter satisfies a specific condition, a mini-skit event through which the current relationship changes to a predetermined relationship may always be caused to occur. In this game, when virtual residents whose current relationship is “stranger” are brought to meet each other through the pinching and dropping operations described above, a mini-skit event through which the current relationship is changed to “acquaintance” is always caused to occur. For example, a mini-skit event in which virtual residents introduce themselves to each other is displayed. Through this event, the affection level is increased to a degree sufficient for the current relationship to change to “acquaintance”.

Here, the case where a mini-skit event does not occur even when the above pinching and dropping operations are performed will be described. First, there may be cases where a mini-skit event is not caused to occur, based on a probability. In this game, such a probability of causing a mini-skit event to occur is set to be quite low. Next, for a combination of virtual residents for which a mini-skit event has occurred, when a predetermined time has not elapsed since the last mini-skit event, there may be cases where a mini-skit event is not caused to occur again. Furthermore, depending on the contents of the “current relationship” and the mood states determined by the mood parameters of the virtual residents, there may be cases where a mini-skit event does not occur. For example, the case where the mood state of the virtual resident B is “feeling down” is considered. The mood parameter may change as a result of the conversation event as described above. Then, it is assumed that the virtual resident A is brought to meet the virtual resident B through the operations described above. In this case, if the “current relationship” between the virtual resident A and the virtual resident B is not a predetermined relationship, a mini-skit event does not occur. Specifically, if the “current relationship” between the virtual resident A and the virtual resident B is a relationship other than “friend”, a mini-skit event does not occur. On the other hand, if the “current relationship” between the virtual resident A and the virtual resident B is “friend”, a mini-skit event in which the virtual resident A cheers up the virtual resident B (this is sometimes also referred to as mood recovery event) occurs. As a result, the mood parameter of the virtual resident B changes such that the mood state of “feeling down” is eliminated. That is, the mood parameter changes to shift toward a positive mood state. Consequently, the virtual resident B whose “feeling down” state has been eliminated returns to a state where it is possible for a mini-skit event to occur even with a virtual resident other than “friend”. That is, the user is required to bring a virtual resident having an appropriate human relationship (in this case, friend) to meet a virtual resident who is in a “feeling down” state. In this case, by displaying the correlation diagram image described above, it becomes easier to determine which virtual resident should be brought. Additionally, if a virtual resident having a low affection level is brought to meet a virtual resident who is in a “feeling down” state, the “feeling down” state may be changed to be deepened. In this case, the change may be caused by causing a mini-skit event to occur, or may be caused by causing a conversation event to occur as described above, without causing a mini-skit event to occur.

### Dialogue screen

When the finger‑shaped cursor is aligned with the virtual resident A as shown in FIG. 10 above, if the user performs a short-press operation on the A-button 53, not a long-press operation (pinching operation) on the A-button 53, the screen can transition to a dialogue screen in which the user can converse with the virtual resident A. In the dialogue screen, it is possible to increase the “satisfaction level” of the virtual resident being spoken to. The satisfaction level is a parameter provided for each virtual resident, and when the satisfaction level exceeds a certain value, the virtual resident levels up. While the dialogue screen is displayed, the flow of time within the virtual town is temporarily halted.

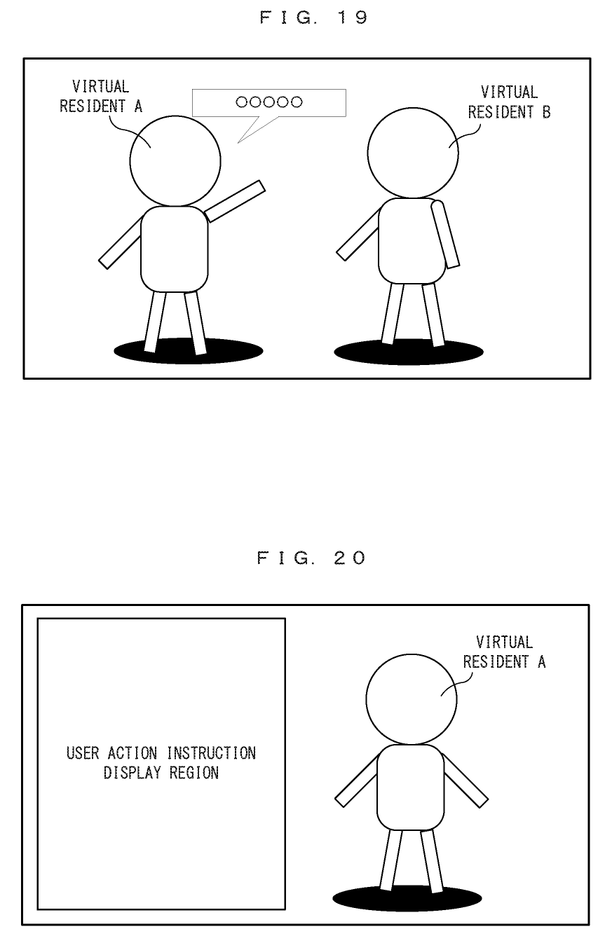

FIG. 20 shows an example of the dialogue screen. In the screen example of FIG. 20, a virtual resident to be conversed with is displayed on substantially the right half of the screen. A region (user action instruction region) for specifying an action (user action) that the user can perform toward the virtual resident is displayed on substantially the left half of the screen. As an example of the user action, the user can give a virtual item owned by the user, to the virtual resident as a gift, thereby increasing the satisfaction level. In the dialogue screen, the virtual resident may present a “request” such as “wanting a particular item”. In such a case, fulfilling the request can increase the satisfaction level. Moreover, the virtual resident may also be in a state of having a “concern”. In such a case, in the dialogue screen, the virtual resident consults the user about a concern, and options representing advice are displayed in the user action instruction region. The user can select advice and provide a response as a user action, and if the concern is resolved, the satisfaction level increases.

When the mood parameter of the virtual resident is a specific state such as the “feeling down” state described above, the satisfaction level cannot be increased until that state is eliminated.

Here, the user can purchase a virtual item to be used as the gift, for example, at a shop or the like in the virtual town by using in‑game currency. Supplementary description will be given regarding the acquisition of in‑game currency. In this game, the user can accumulate in‑game currency over time. Specifically, as with a so‑called “login bonus”, in‑game currency is given to the user once per day upon logging into the game. In this game, as for the amount of in‑game currency to be given, a predetermined amount of in‑game currency is provided by each virtual resident in the virtual town, and the total of these amounts is given to the user. The amount provided by each virtual resident is determined based on the satisfaction level thereof, and the higher the satisfaction level, the greater the amount of in‑game currency provided. That is, by increasing the satisfaction level of the virtual resident, the user can obtain a greater amount of in‑game currency.

Although not shown, the satisfaction level may be displayed, for example, as a “satisfaction level gauge” in the dialogue screen or the like. The user can visually grasp the state of the satisfaction level. Furthermore, when the virtual resident is in a state where the satisfaction level cannot be increased such as the “feeling down” state described above, a “feeling‑down gauge” may be displayed instead of the satisfaction level gauge. This allows the user to visually recognize that the satisfaction level cannot be increased unless the feeling‑down gauge is reduced to zero.

### User experience points

As a result of conversation with a virtual resident as described above, the user may receive a “user experience point item” (hereinafter, user experience points) from the virtual resident. By accumulating these user experience points, the user can rank up their user rank. In this game, user experience points can be obtained from a virtual resident when the mood parameter of the virtual resident satisfies a predetermined condition. For example, if the user resolves a concern of the virtual resident on the dialogue screen, and as a result, the mood parameter of the virtual resident becomes “cheerful”, user experience points are given as a “thank‑you” to the user. When the user rank rises, the number of types of virtual items that the user can purchase increases, and the number of types of buildings and various objects that can be placed within the virtual town also increases. In addition, the user becomes able to give a “trip” as a gift to a virtual resident. Giving such a trip makes it possible to cause a special event such as a “trip event” to occur. The trip event may be, for example, an event through which the human relationship parameter of the virtual residents who take a trip together is changed to a closer relationship.

### Follow mode

Meanwhile, the example in which the finger‑shaped cursor (reference point) is moved with the left stick 32 and the virtual camera (gazing point) also moves accordingly, has been described above. That is, the example in which the user freely moves the virtual camera using the left stick 32 has been described. Regarding this camera movement control, in this game, in addition to the mode in which the virtual camera is moved based on an operation performed by the user as described above (hereinafter, free movement mode), there is also a movement control mode called “follow mode”. In this mode, control in which a predetermined virtual resident is locked onto (as an observation target) and the virtual camera is automatically moved so as to follow that virtual resident, is performed. The follow mode will be described below using screen examples.

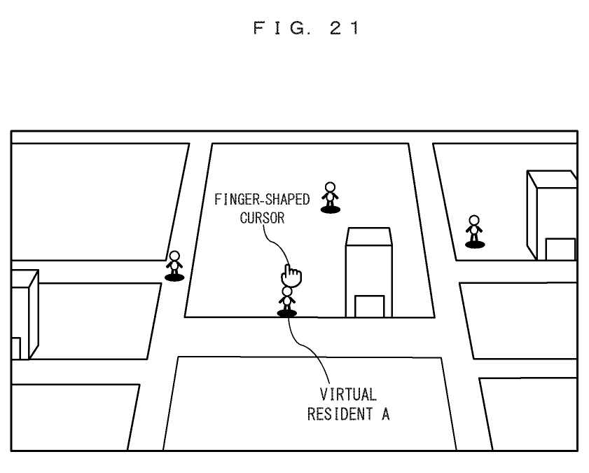

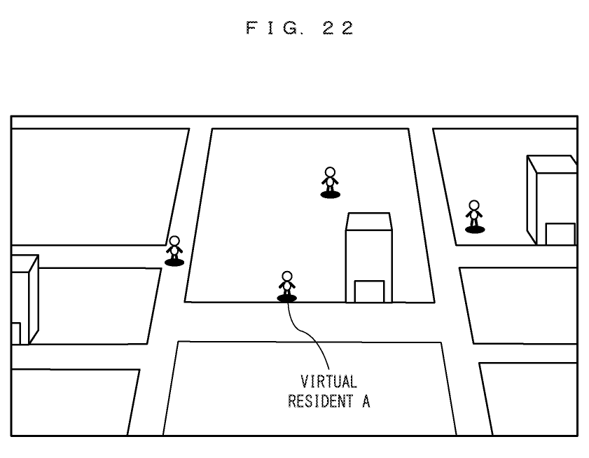

First, for example, as shown in FIG. 21, the finger‑shaped cursor is moved such that the finger‑shaped cursor overlaps the virtual resident A. In this example, when a part of the finger‑shaped cursor overlaps the virtual resident A, the mode transitions to the follow mode in which the virtual resident A is set as a follow target. At this time, the finger‑shaped cursor is displayed as if being adhered to the virtual resident A. For example, the midpoint of the finger-shaped cursor is set to coincide with the midpoint of the virtual resident A. Then, if neither the left stick 32 nor the A-button 53 is operated, the finger‑shaped cursor gradually becomes transparent over time, and eventually becomes hidden, as shown in FIG. 22. Until the finger‑shaped cursor becomes fully transparent, the finger‑shaped cursor moves together with the virtual resident A while being adhered to the virtual resident A unless the left stick 32 is operated, and accordingly, the virtual camera (strictly speaking, the reference point) also moves while capturing the virtual resident A in the front direction of the virtual camera. If the user performs the above pinching operation before the finger‑shaped cursor becomes fully transparent, the user experiences a feeling as if the user aligned the finger‑shaped cursor with the virtual resident A and performed the pinching operation.

In another exemplary embodiment, after the adhered finger‑shaped cursor becomes hidden, for example, a white outline may be displayed around the virtual resident with which the finger‑shaped cursor has been aligned, for a predetermined time.

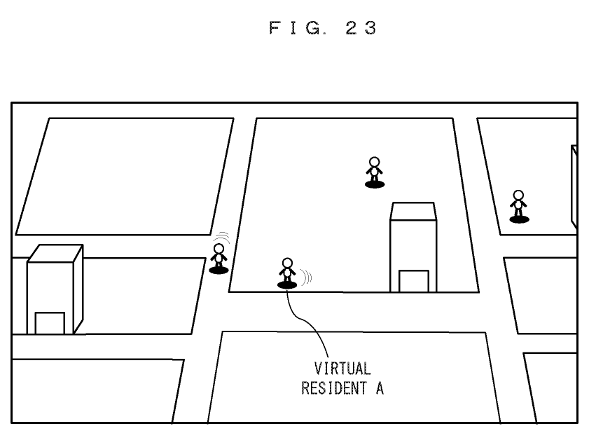

Then, if the virtual resident A moves leftward as shown in FIG. 23, the virtual camera moves so as to follow the virtual resident A. Therefore, the user can follow and observe a specific virtual resident without performing any operation. In addition, since the finger‑shaped cursor is hidden, it is easier to visually recognize the states of the virtual town and the virtual resident A. Hereinafter, the virtual resident being followed in the follow mode is sometimes also referred to as follow target character.

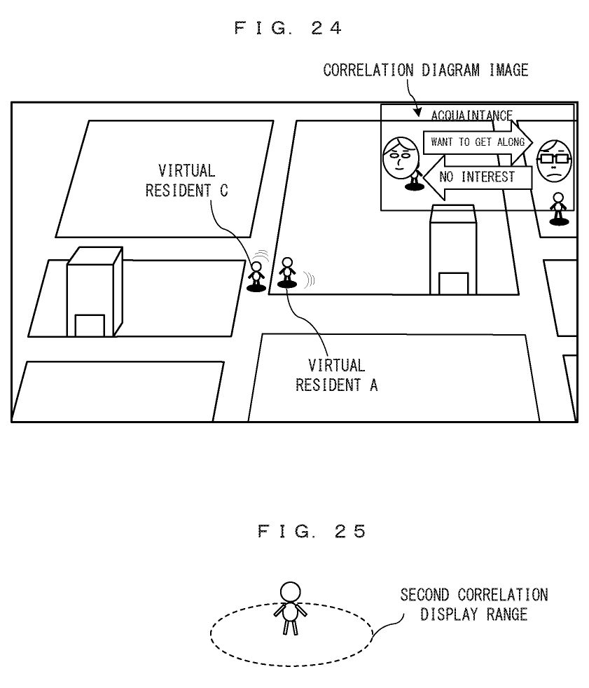

Subsequently, when the virtual resident A further moves, for example, to establish a positional relationship in which the virtual resident C is within a predetermined range based on the position of the virtual resident A as shown in FIG. 24, a correlation diagram image indicating the human relationship between the virtual resident A and the virtual resident C is displayed. In this case, the virtual resident A which is a follow target is the correlation reference character, and the virtual resident C is the correlation target character. The predetermined range is, for example, a circular range centered on the virtual resident A as shown in FIG. 25. Hereinafter, this range in the follow mode is sometimes also referred to as second correlation display range. The size of the second correlation display range may be the same as or different from that of the first correlation display range. By displaying the correlation diagram image when another virtual resident is near the virtual resident being followed (in other words, being observed), it is possible to provide the user with motivation to cause a mini-skit event to occur.

By performing a directional input operation on the left stick 32 in the follow mode, the user can cancel the follow mode and return to the free movement mode. When the free movement mode is returned to, the finger‑shaped cursor is also displayed. In addition, by performing a long-press operation (pinching operation) on the A-button 53 in the follow mode, the user can transition the follow target into the pinched state and lift the follow target. In this case as well, the follow mode is cancelled. Moreover, by performing a short-press operation on the A-button 53 in the follow mode, the user can shift to the dialogue screen described above.

In this game, when the user is not moving the finger‑shaped cursor (and a circular cursor described later), and a virtual resident in a non‑pinched state approaches and overlaps the finger‑shaped cursor, the mode is not switched to the follow mode. Accordingly, following that is not intended by the user can be avoided.

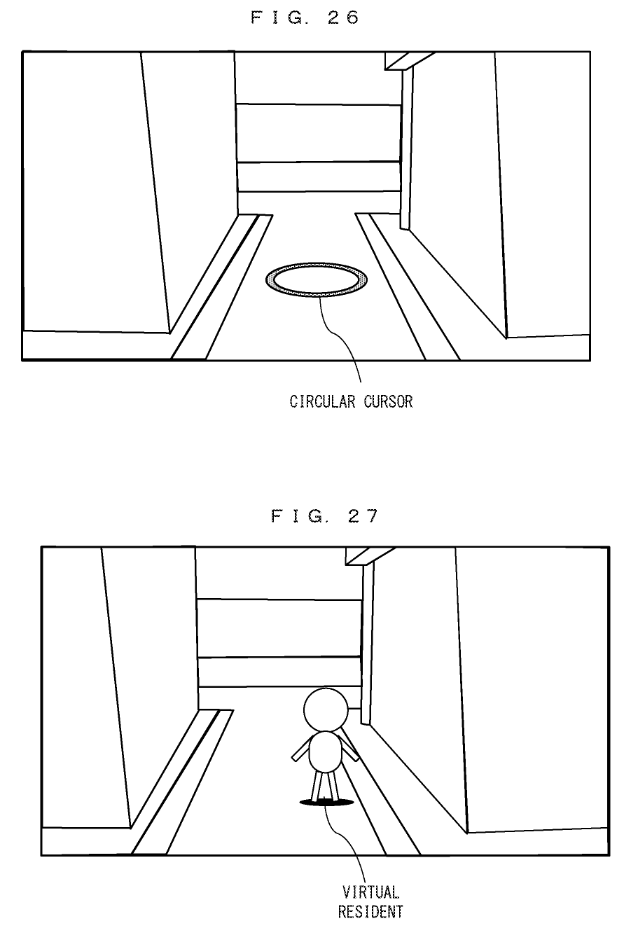

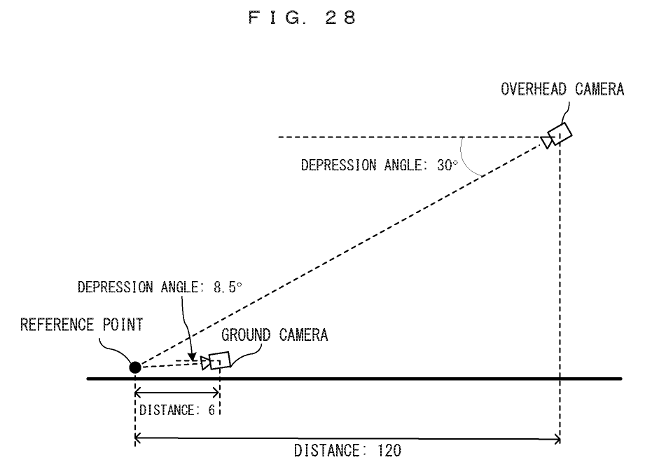

Regarding the control of the virtual camera, in addition to the free movement mode and the follow mode for movement control described above, in this game, two camera modes with different positions, depression angles, etc., are prepared. One of the two camera modes is an overhead camera mode (hereinafter referred to as overhead camera) in which the virtual camera is positioned at a location and distance that provide an overhead viewpoint, such as that shown in FIG. 8. The other of the two camera modes is a ground camera mode (hereinafter referred to as ground camera) in which the virtual camera is positioned closer to the ground surface of the virtual town. FIG. 26 shows a screen example of the ground camera in the case where the mode of movement control is the free movement mode. FIG. 27 shows a screen example of the ground camera in the case where the mode of movement control is the follow mode. FIG. 28 shows a schematic diagram illustrating the differences in position and orientation between the overhead camera and the ground camera.

As shown in FIG. 28, in this game, the overhead camera is positioned at a distance of “120” from the reference point with a depression angle of 30°. Meanwhile, the ground camera is positioned closer to the ground surface of the virtual town compared to the overhead camera, and is located at a distance of “6” from the reference point with a depression angle of 8.5°. In addition, the position of the ground camera is determined based on a relative position from the gazing point. In this game, it is possible to switch between the “overhead camera” and the “ground camera” by operating the right stick 52 in the up-down direction. That is, when the right stick 52 is tilted to input the “up direction” at the time of the overhead camera, the virtual camera switches to the ground camera. In addition, when the right stick 52 is tilted to input the “down direction” at the time of the ground camera, the virtual camera can be switched from the ground camera to the overhead camera. In such switching, the game screen may be instantly switched, or a representation in which the virtual camera gradually switches may be inserted.

In the example of the ground camera shown in FIG. 26 and FIG. 27, a game image is displayed as seen from a viewpoint close to the eye level of a virtual resident, near the ground surface of the virtual town. Therefore, compared to the case of the overhead camera, it is possible to move within the virtual town at the eye level of a virtual resident, thereby providing a game image having greater realism. In FIG. 26, a circular cursor is displayed in place of the finger‑shaped cursor. In the following description, the above finger‑shaped cursor and the circular cursor are sometimes collectively referred to simply as “cursor”. In this screen as well, an invisible reference point is provided as in the above, and the position of the virtual camera, the position of the gazing point, and the position of the circular cursor are determined based on this reference point. Therefore, the user visually perceives an operational feel as if operating the circular cursor. Specifically, the user changes the X‑coordinate and the Z‑coordinate of the reference point in the virtual space by operating the left stick 32. In addition, in this screen, a raycast is performed from the reference point toward the ground, and the Y‑coordinate of the reference point is determined such that the reference point is positioned slightly above the ground.

The X‑coordinate and the Z‑coordinate of the gazing point in the game screen in FIG. 26 or FIG. 27 are set to the same coordinates as those of the reference point, and the Y‑coordinate of the gazing point is set such that the position of the gazing point becomes the most stable position based on the history of the Y‑coordinate of the reference point. Specifically, when the Y‑coordinate of the reference point has not changed for a while, or when the reference point moves from a lowland area to a highland area, the Y‑coordinate of the gazing point is set to the same Y‑coordinate as that of the reference point. On the other hand, when the reference point moves from a highland area to a lowland area, the Y‑coordinate of the gazing point is not updated. Accordingly, even when the reference point is moved in terrain where the height of the reference point tends to fluctuate, camera control can be performed without causing the gazing point to shake significantly. In this example, the circular cursor is placed at a position obtained by projecting the reference point vertically onto the ground surface.

In the case of the ground camera as well, the basic operations are the same as in the case of the overhead camera. By aligning the circular cursor, instead of the finger‑shaped cursor, with a virtual resident, the cursor gradually disappears over time, switching to the follow mode, and the follow mode can be cancelled by performing a directional input on the left stick 32. Here, in the case of the ground camera, in the free movement mode, by aligning the circular cursor with a virtual resident and performing a long-press operation on the A-button 53, that virtual resident can be pinched and lifted. In the case of the follow mode, since the cursor is hidden, the currently followed virtual resident can be pinched and lifted by simply performing a long-press operation on the A-button 53. In either case, by performing the pinching operation, the camera mode is switched from the ground camera to the overhead camera. In addition, if there is a currently pinched character, the overhead camera is fixed, and the operation for switching to the ground camera is also disabled.

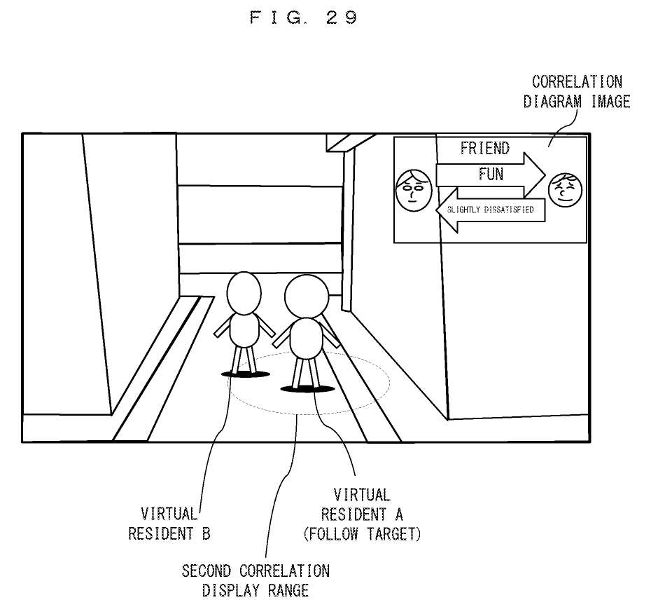

In the case of the ground camera, as with the case of the overhead camera, if another virtual resident exists within the second correlation display range, a correlation diagram can be displayed. FIG. 29 shows an example of the correlation diagram display in the case of the follow mode in the ground camera. In FIG. 29, the virtual resident B exists within the second correlation display range of the virtual resident A which is a follow target character. When such a positional relationship is established as a result of autonomous movement of each virtual resident, a correlation diagram indicating the human relationship between these virtual residents is displayed.

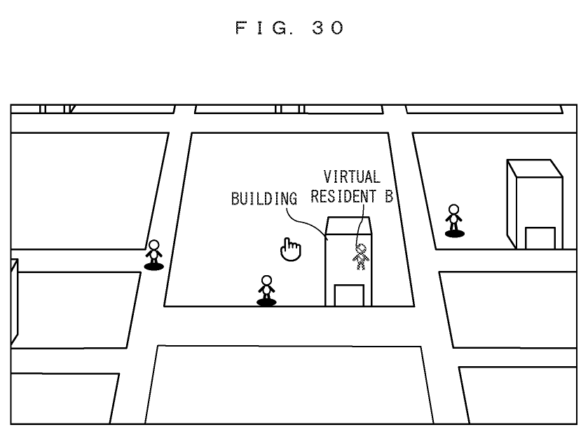

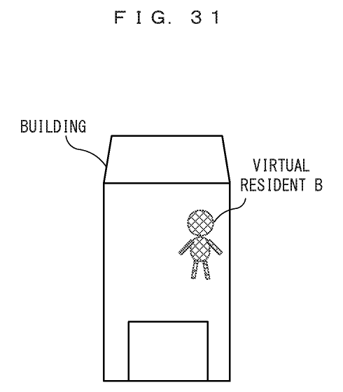

Here, in this game, in the case of the overhead camera, control in which an effect called “dither display” is applied to a virtual resident positioned such that the virtual resident is blocked by a building or the like and thus not visible from the virtual camera, is also performed. In the exemplary embodiment, the dither display is an effect in which a virtual resident is displayed using a mesh‑like cutout image. FIG. 30 and FIG. 31 show an example of the dither display. FIG. 31 is an enlarged schematic diagram of an area around the virtual resident displayed with dithering in FIG. 30. In these drawings, the virtual resident B is located behind a building. Therefore, the virtual resident B is blocked and not visible when seen from the virtual camera, and in the case of such a positional relationship, the dither display is applied to the virtual resident B, thereby indicating the presence of the virtual resident B. Accordingly, in the case of the overhead camera, the user can be allowed to recognize the presence of a virtual resident who is blocked by a building and thus not visible. By allowing the user to recognize the presence of another virtual resident as described above, it is possible to provide more information for determining the destination of the currently pinched character.

In this game, in the case of the ground camera, control is performed such that realism is prioritized and dither display is not performed even when a virtual resident is blocked by a building. In this regard, in another exemplary embodiment, in the case of the ground camera, dither display control may also be performed.

In the exemplary embodiment, description will be given with the example in which two camera modes, the overhead camera and the ground camera, are used. However, in another exemplary embodiment, camera modes with different distances and depression angles may also be used. For example, the overhead camera may be regarded as a “long‑shot” view, the ground camera may be regarded as a “close‑up” view, and it may be possible to switch to a “medium‑shot” camera mode positioned between the two modes. In such a case, the above‑described dither display control may be set to be performed, for example, only in the “medium-shot” and “long-shot” modes.

### List screen

In this game, by pinching and lifting a virtual resident and moving the finger‑shaped cursor through a left stick operation, it is possible to move the currently pinched character to the position of a certain virtual resident and bring the currently pinched character to meet the certain virtual resident. Meanwhile, a plurality of virtual residents exist in the virtual town. For bringing to meet a virtual resident, the pinching and dropping operations may be performed each time, but to improve convenience, a list screen in which a virtual resident list is displayed is also provided in this game. When the list screen is used, it is possible to specify a particular virtual resident and move to the position of the virtual resident. In this game, the list screen can be displayed, for example, by pressing the X-button 55. While the list screen is displayed, the flow of time within the virtual town may be temporarily halted.

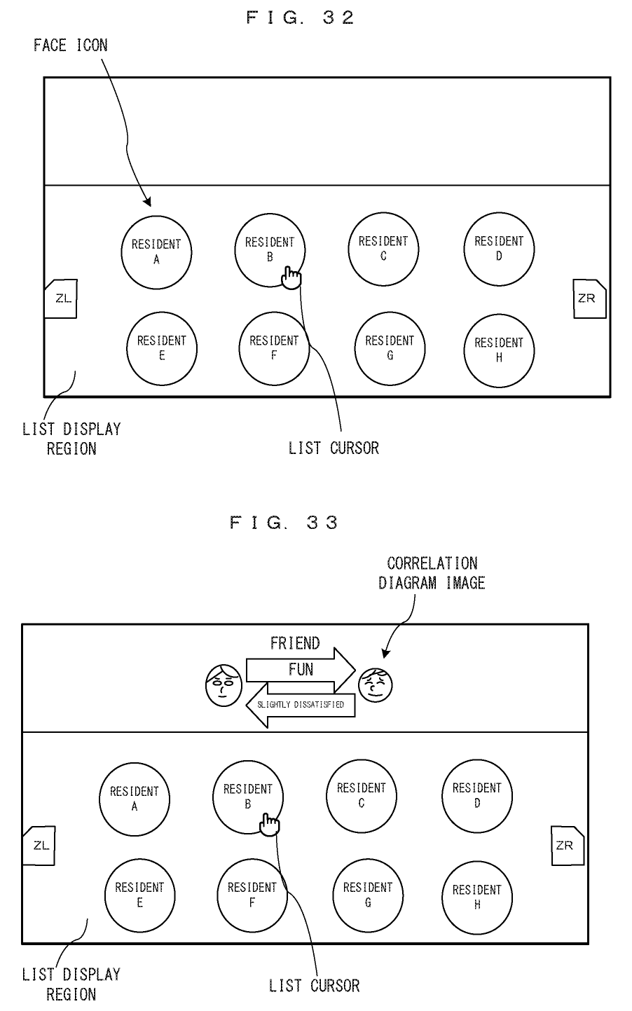

FIG. 32 shows an example of the list screen in the case where there is no currently pinched character and there is no follow target character. In the list screen shown in FIG. 32, a list display region in which a list of face icons respectively corresponding to all virtual residents in the virtual town is displayed is included in a lower part of the screen. This region can be scrolled. Although not shown, personal information such as the names of the virtual residents may be displayed in addition to the face icons. The user can operate a list cursor to select the face icon of a desired virtual resident. By performing a confirmation operation, short-pressing the A-button 53 in this game, in a state where a certain face icon is selected, it is possible to confirm the selection of the virtual resident, close the list screen, and move to the position of the selected virtual resident. As for this movement, in the case of the overhead camera, the finger‑shaped cursor is moved with a representation in which the finger‑shaped cursor moves at a high speed from the current position to the position of this virtual resident. In the case of the ground camera, the virtual camera (reference point) moves instantaneously to a position close to this virtual resident. As described above, by using the list screen, it is possible to easily move to the position of a specified virtual resident. In the following description, specifying a certain virtual resident from the list screen and moving thereto is referred to “list movement”.

Furthermore, when list movement is performed as described above in the case where there is no currently pinched character and there is no follow target character, the mode is automatically switched to the follow mode in which the specified virtual resident is a follow target character, after the movement.

FIG. 33 shows an example of the list screen displayed in the case where there is a currently pinched character or a follow target character. In FIG. 33, a correlation diagram image is also displayed above the list display region. The correlation diagram image is a correlation diagram image in which a currently pinched character or a follow target character is set as the correlation reference character and a virtual resident currently selected by a list cursor is set as the correlation target character. Therefore, each time the selection target is changed using the list cursor, the display content of the correlation diagram image (correlation target character) is also changed accordingly.

Here, supplementary description will be given regarding the case where a virtual resident currently selected by the list cursor has been grouped as described above. In this case, in the exemplary embodiment, only the virtual resident currently selected by the list cursor is set as the correlation target character. In this regard, in another exemplary embodiment, when a virtual resident selected in the list has been grouped at that time, all virtual residents belonging to that group may be set as correlation target characters.

Next, the behavior when list movement is performed in a state where there is a currently pinched character or a follow target character will be described. First, when list movement is performed in a state where there is a follow target character, that is, in the follow mode, the reference point moves to a position close to a virtual resident specified from the list, and the list screen is closed. That is, a screen in which the reference point, the cursor, the gazing point, and the virtual camera have moved to the position close to the virtual resident specified from the list, is displayed. In this case, the virtual resident specified from the list is set as a new follow target.

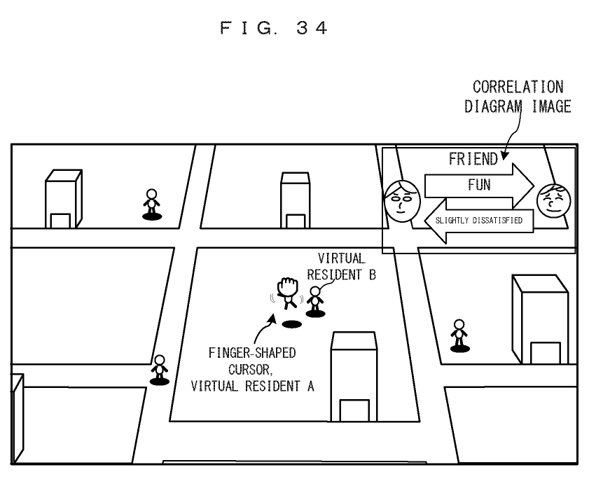

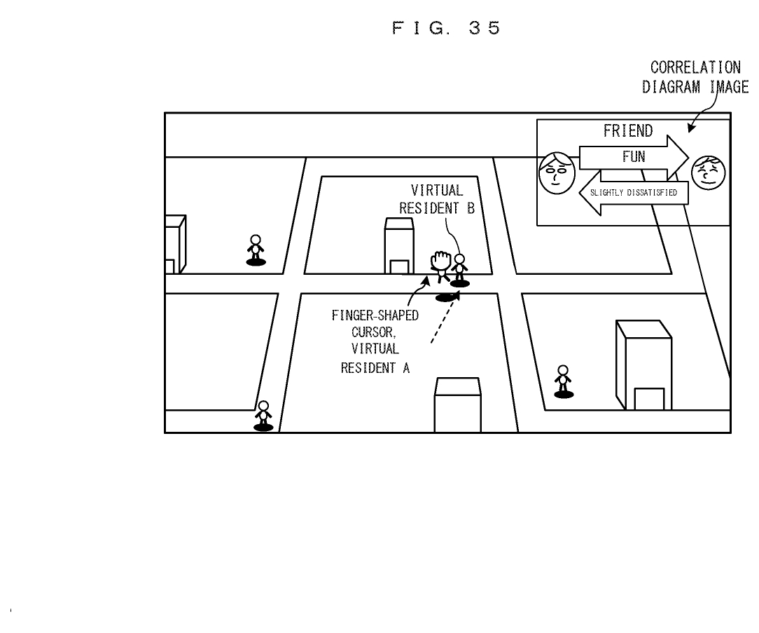

On the other hand, when list movement is performed in a state where there is a currently pinched character in the free movement mode, the finger‑shaped cursor holding the currently pinched character is displayed in a state where the finger‑shaped cursor has moved to the vicinity of the virtual resident specified from the list, as shown in FIG. 34. Then, in this case, the mode is switched to the follow mode with the other virtual resident as the follow target character. As a result, the behavior of the finger‑shaped cursor following the other virtual resident while holding the currently pinched character is displayed. For example, when the virtual resident B moves in the upper-right direction of the screen from the state of FIG. 34, control in which the virtual camera is moved so as to follow the virtual resident B while the finger‑shaped cursor and the currently pinched character are displayed at substantially the center of the screen as shown in FIG. 35, is performed. Therefore, after list movement, even if the virtual resident at the movement destination starts moving, the currently pinched character also moves following this virtual resident, thereby allowing the user to easily cause a mini-skit event to occur simply by performing the dropping operation.

### Data to be used

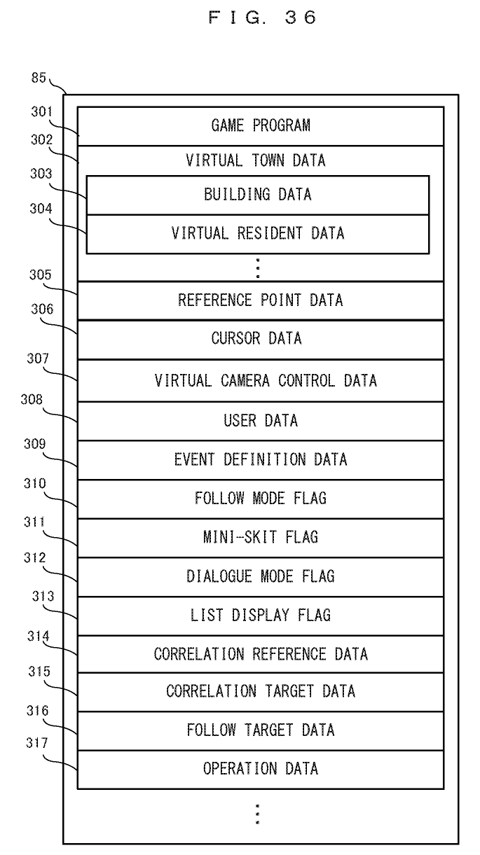

Next, various data to be used in the game processing will be described. FIG. 36 is a memory map showing an example of various data stored in the DRAM 85 of the main body apparatus 2. The content of each data will be described below.

A game program 301 is a program containing instructions that cause the processor 81 to execute the game processing described above.

Virtual town data 302 is data that defines the structure, etc., of the virtual town. The virtual town data 302 includes at least building data 303 and virtual resident data 304.

The building data 303 is data regarding various buildings placed within the virtual town. For example, data indicating the placement position of each building, the type of the building, etc., is included.

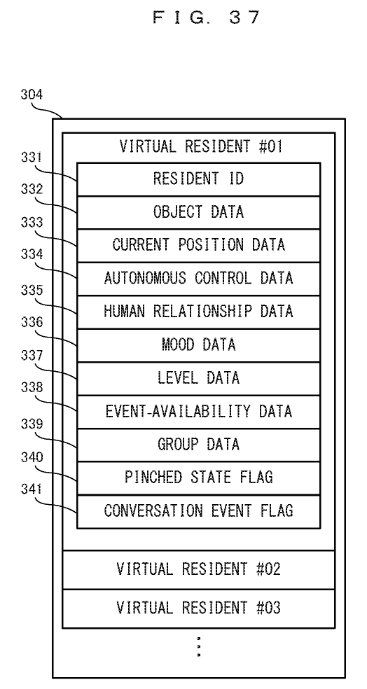

The virtual resident data 304 is data regarding each virtual resident placed within the virtual town. FIG. 37 shows an example of the data structure of the virtual resident data 304. For each virtual resident, the virtual resident data 304 includes at least the following various data: a resident ID 331, object data 332, current position data 333, autonomous control data 334, human relationship data 335, mood data 336, level data 337, event‑availability data 338, group data 339, a pinched state flag 340, and a conversation event flag 341.

The resident ID 331 is an identifier for each virtual resident. The object data 332 is data indicating the appearance of the virtual resident, such as 3D model data and image data. The current position data 333 is data indicating the current position of the virtual resident within the virtual town. The autonomous control data 334 is data (an algorithm) that defines the actions of the virtual resident in a non‑pinched state.

The human relationship data 335 is data corresponding to the human relationship parameter described above and includes parameters indicating the “current relationship”, the “affection level”, and the “feeling” described above. The mood data 336 is data corresponding to the mood parameter described above, and based on the value thereof, the mood state described above can be determined.

The level data 337 includes data indicating the current level and the current satisfaction level of the virtual resident.

The event‑availability data 338 is data that is set when it is possible for a mini-skit event with the currently pinched character to occur, and includes the following data. Data specifying the partner of the mini-skit event (currently pinched character) is included. In addition, data indicating the mini-skit event to be executed (e.g., an event ID 351 described later) and data indicating parameters that change as a result of executing the mini-skit event and the values by which the parameters are increased or decreased is included.

When grouping is performed at the time of the conversation event, information for identifying that group, such as a group ID, is set as the group data 339.

The pinched state flag 340 is a flag indicating whether the virtual resident is in the “non‑pinched state” or the “pinched state”. The pinched state flag 340 is set to ON when the virtual resident is in the “pinched state”.

The conversation event flag 341 is a flag indicating whether the virtual resident is currently engaged in a conversation event with another virtual resident. When the conversation event flag 341 is ON, the conversation event flag 341 indicates that a conversation event is being executed.

Referring back to FIG. 36, reference point data 305 is data indicating the position of the reference point within the virtual space.

Cursor data 306 is data regarding the above cursor. The cursor data 306 includes cursor position data indicating the display position of the cursor, display form data indicating the display form of the cursor (finger‑shaped cursor or circular cursor), a cursor display flag indicating whether the cursor is to be displayed, etc.

Virtual camera control data 307 is data for controlling the virtual camera. The virtual camera control data 307 includes camera mode data indicating whether the camera mode is the overhead camera or the ground camera, gazing point data indicating the gazing point of the virtual camera, and parameter sets respectively corresponding to the overhead camera and the ground camera. Each parameter set includes various parameters indicating the position, the imaging direction, the depression angle, the angle of view, etc., of the virtual camera in the corresponding mode. For example, when the camera mode data indicates the overhead camera, control in which the parameter set for the overhead camera is used, is performed.

User data 308 is data regarding the user. The user data 308 includes rank data indicating the above user rank, possession‑amount data indicating the amount of in‑game currency held by the user, owned‑item data indicating the items owned by the user, user experience point data indicating the user experience points given to the user, etc.

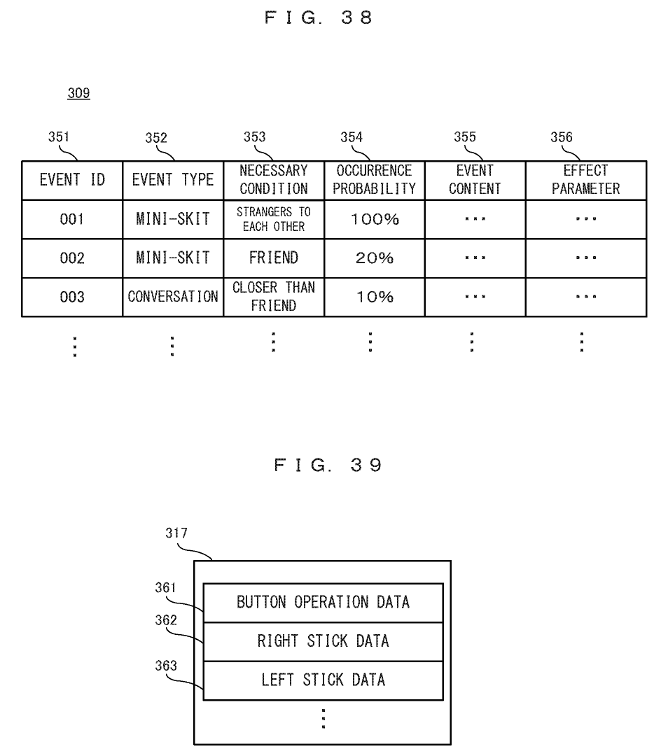

The event definition data 309 is data that defines the contents of the above‑described conversation events and mini-skit events. FIG. 38 shows an example of the data structure of the event definition data 309. The event definition data 309 is data in a table format composed of a set of records each having items such as the event ID 351, an event type 352, a necessary condition 353, an occurrence probability 354, an event content 355, and an effect parameter 356.

The event ID 351 is an identifier for each event. The event type 352 indicates whether the event is a mini-skit event or a conversation event.

The necessary condition 353 defines a condition necessary for the event to occur, and a required “current relationship”, a required mood parameter, or the like is defined. For example, in the mood recovery event described above, a condition that the current relationship is “friend” and the mood parameter of one of the virtual residents engaged in the event is “feeling down”, is defined. In addition, the condition is also defined such that the closer the “current relationship” is, the greater the number of types of corresponding events is, as described above.

The occurrence probability 354 indicates the likelihood that the event will occur. The event content 355 is data that defines the specific content of the event. For example, the event content 355 includes text representing conversation content, data of various motions to be performed by virtual residents in a mini-skit event, etc. The event content 355 may be, for example, video data. The effect parameter 356 is data specifying a human relationship parameter and a mood parameter that can change as a result of the event, and defining the values by which the parameters are increased or decreased when changed and the contents of the changes.

Referring back to FIG. 36, a follow mode flag 310 is a flag indicating whether control is currently performed in the free movement mode or the follow mode. When the follow mode flag 310 is OFF, the follow mode flag 310 indicates that control is performed in the free movement mode, and when the follow mode flag 310 is ON, the follow mode flag 310 indicates that control is performed in the follow mode. The follow mode flag 310 is initially OFF.

A mini-skit flag 311 is a flag indicating whether a process related to the above‑described mini-skit event is to be executed. The mini-skit flag 311 is initially OFF.

A dialogue mode flag 312 is a flag indicating whether a process related to the dialogue screen shown in FIG. 20 is to be executed. The dialogue mode flag 312 is initially OFF.

A list display flag 313 is a flag indicating whether a process related to the list screen described above is to be executed. The list display flag 313 is initially OFF.

Correlation reference data 314 is data used to identify the correlation reference character described above. Correlation target data 315 is data used to identify the correlation target character described above. Follow target data 316 is data used to identify the follow target character described above.

Operation data 317 is data indicating the contents of various operations performed on the controller. FIG. 39 shows an example of the data structure of the operation data 317. The operation data 317 includes at least button operation data 361, right stick data 362, and left stick data 363. The button operation data 361 is data indicating the contents of operations performed on the various operation buttons described above. The right stick data 362 is data indicating the contents of operations performed on the right stick 52. The left stick data 363 is data indicating the contents of operations performed on the left stick 32.

### Details of game processing

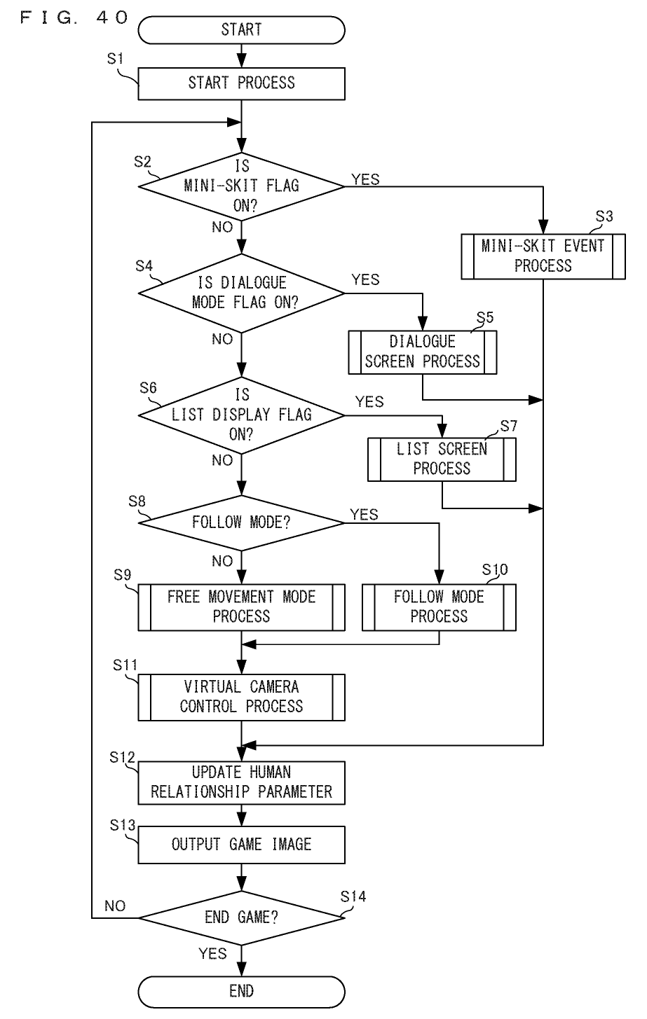

Next, the details of the game processing in the exemplary embodiment will be described with reference to FIG. 40 to FIG. 58.

FIG. 40 is an example of a flowchart showing the processing according to the exemplary embodiment. The processing may include other processing, and part of the processing may be omitted. The order of each process is merely an example, and, for example, the processes may be executed simultaneously or in reverse order. Furthermore, the processes are described as being separated for convenience, but may be implemented as an integrated process. The following processes may also be executed at a predetermined interval (e.g., per processing frame or every 1/30 seconds).

In FIG. 40, first, the processor 81 executes a start process (S1). In this process, various buildings and virtual residents are placed within the virtual space based on the virtual town data 302, thereby generating a virtual town. Various data are also initialized, and the reference point is placed at an initial position. Then, a game image is generated and outputted.

Next, the processor 81 determines whether or not the mini-skit flag 311 is ON (S2). If, as a result of the determination, the mini-skit flag 311 is ON (YES in S2), the processor 81 executes a mini-skit event process described later (S3). On the other hand, if the mini-skit flag 311 is OFF (NO in S2), next, the processor 81 determines whether or not the dialogue mode flag 312 is ON (S4). If the dialogue mode flag 312 is ON (YES in S4), the processor 81 executes a dialogue screen process described later (S5).

On the other hand, if, as a result of the determination in S4, the dialogue mode flag 312 is OFF (NO in S4), next, the processor 81 determines whether or not the list display flag 313 is ON (S6). If the list display flag 313 is ON (YES in S6), the processor 81 executes a list screen process described later (S7).

On the other hand, if, as a result of the determination in S6, the list display flag 313 is OFF (NO in S6), next, the processor 81 determines whether or not the follow mode flag 310 is ON (S8). If the follow mode flag 310 is OFF (NO in S8), the processor 81 executes a free movement mode process (S9), and if the follow mode flag 310 is ON (YES in S8), the processor 81 executes a follow mode process (S10).

### Free movement mode process

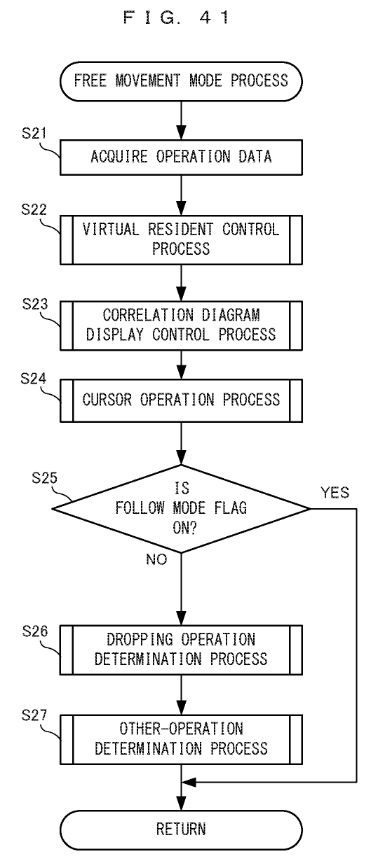

FIG. 41 is a flowchart showing the details of the free movement mode process. First, the processor 81 acquires the operation data 317 (S21).

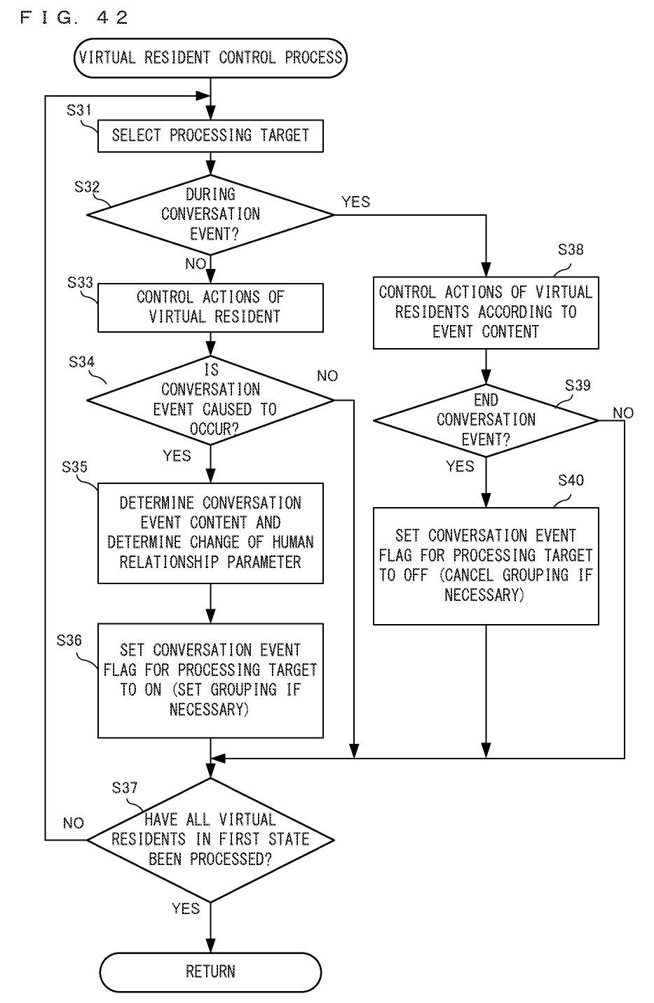

Next, the processor 81 executes a virtual resident control process (S22). FIG. 42 is a flowchart showing the details of the virtual resident control process. In FIG. 42, first, the processor 81 selects one virtual resident as a target for the processing described below (hereinafter referred to as processing target resident) (S31). Next, the processor 81 determines whether or not the processing target resident is currently engaged in a conversation event (S32). If the processing target resident is not currently engaged in a conversation event (NO in S32), the processor 81 controls the actions of the processing target resident, based on the autonomous control data 334 (S33). Accordingly, the processing target resident can be moved. In addition, at this time, if a currently pinched character is specified in the event‑availability data 338, the processing target resident is caused to perform a behavior in which the processing target resident turns its gaze toward the currently pinched character.

Next, the processor 81 determines whether or not a conversation event is to be caused to occur for the processing target resident (S34). For example, when the human relationship parameter or the mood parameter satisfies a predetermined condition between the processing target resident and another virtual resident present within a predetermined range from the processing target resident, a random selection process is performed using an occurrence probability corresponding to the predetermined condition. If the result of the random selection is a success, the conversation event is determined to be caused to occur. If, as a result of the determination, the conversation event is determined to be caused to occur (YES in S34), next, the processor 81 determines the content of the conversation event, based on the event definition data 309 (S35). For example, in the above random selection, an event ID 351 is selected, an event is specified based on the selected event ID 351, and a predefined conversation pattern is determined. Prior to the conversation event, whether to change the human relationship parameter is randomly determined. If the human relationship parameter is to be changed, the content to be changed (the value by which the above affection level is increased or decreased) is also determined. In a process (S12) described later, the human relationship parameter is updated based on the determined change content. Thus, for example, the affection level between the virtual residents who have conversed may increase or decrease, and the “current relationship” may also change accordingly. Additionally, for example, it may be determined to change the mood parameter of the virtual resident in a non‑pinched state, and the content of the change may be determined. For example, it may be determined to change the mood state of the virtual resident to a “feeling-down” state as described above. When the human relationship parameter is updated in a process described later, the mood parameter is also updated as appropriate based on the determined content.

Next, the processor 81 sets the conversation event flag 341 for the processing target resident to ON (S36). At this time, if the conversation event involves three virtual residents, for example, the content of the group data 339 is also set as appropriate, for example, by assigning a group ID.

On the other hand, if, as a result of the determination in S34 above, it is determined that a conversation event will not occur (NO in S34), the processes in S35 and S36 above are skipped.

Next, the processor 81 determines whether or not the above processing has been performed for all virtual residents who are in a non‑pinched state (S37). If any unprocessed virtual resident remains (NO in S37), the processor 81 returns to S31 above and repeats the processing. If the processing has been performed for all the virtual residents (YES in S37), the virtual resident control process ends.

On the other hand, if, as a result of the determination in S32 above, the processing target resident is currently engaged in a conversation event (YES in S32), the processor 81 controls the actions of the virtual residents according to the content of the conversation event (S38).

Next, the processor 81 determines whether or not the conversation event has finished (S39). If the conversation event has finished (YES in S39), the processor 81 sets the conversation event flag 341 for the processing target resident to OFF (S40). If grouping has been performed, the processor 81 clears the content of the group data 339 and cancels the grouping. On the other hand, if the conversation event has not yet finished (NO in S39), the process in S40 is skipped. Then, the processor 81 proceeds to the process in step S37.

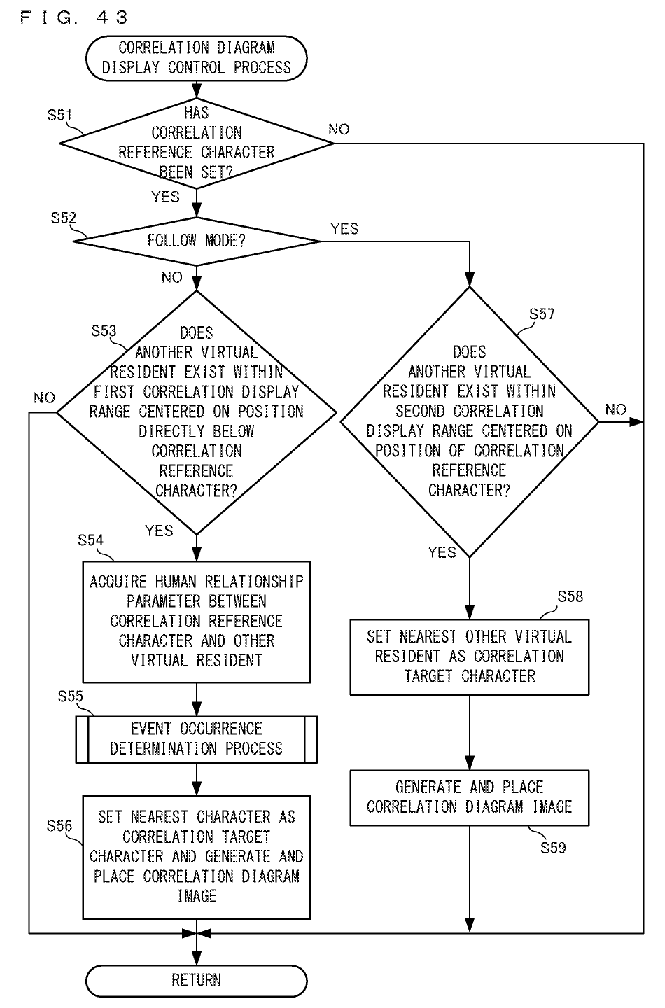

Referring back to FIG. 41, next, the processor 81 executes a correlation diagram display control process (S23). FIG. 43 is a flowchart showing the details of the correlation diagram display control process. First, the processor 81 determines whether or not the correlation reference character has been set, based on the correlation reference data 314 (S51). If, as a result of the determination, no correlation reference character has been set (NO in S51), the correlation diagram display control process ends.

On the other hand, if the correlation reference character has been set (YES in S51), next, the processor 81 determines whether or not the current mode is the follow mode (S52). If, as a result of the determination, the current mode is not the follow mode (NO in S52), the current state is a state where a currently pinched character exists and is set as the correlation reference character. In this case, the processor 81 determines whether or not at least one other virtual resident exists within the first correlation display range (S53). If at least one other virtual resident exists within the first correlation display range (YES in S53), the processor 81 acquires the human relationship data 335 between the correlation reference character and the other virtual resident (S54).

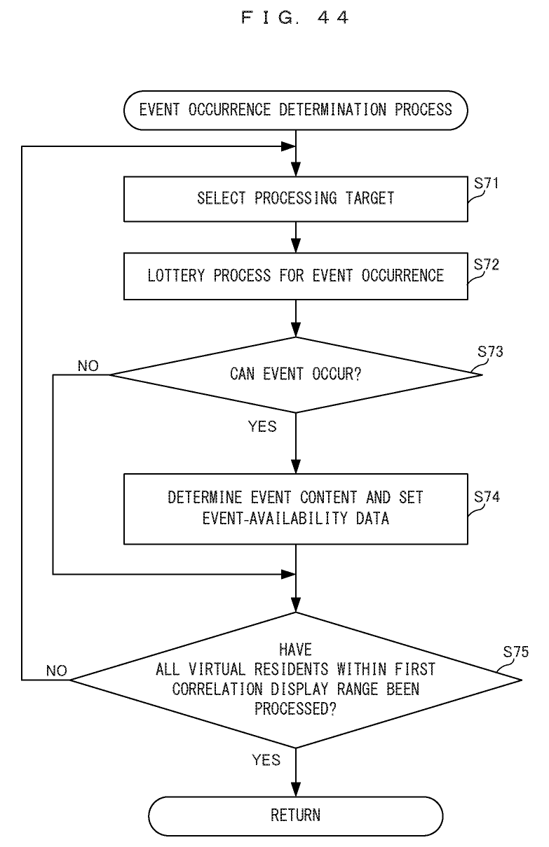

Next, the processor 81 executes an event occurrence determination process (S55). FIG. 44 is a flowchart showing the details of this process. First, the processor 81 selects one target for the following processing (processing target character) from among the virtual residents existing within the first correlation display range (S71).

Next, the processor 81 performs a random selection process for the occurrence of a mini-skit event (S72). For example, the processor 81 extracts any event that can occur, based on the current relationship between and the mood states of the processing target character and the currently pinched character and the necessary condition 353. Furthermore, the processor 81 performs random selection for the extracted events based on the occurrence probability 354 of each event to determine the mini-skit event that can occur. For this random selection, there is also a low‑probability random selection result representing “no event occurs”. Additionally, when performing the random selection, if a specific human relationship defined in the necessary condition 353 is satisfied, a specific mini-skit event may be determined without performing the random selection. In this game, if the correlation reference character and the processing target character are “strangers” to each other, a mini-skit event through which the “current relationship” is changed to “acquaintance” is determined.

Next, the processor 81 determines whether or not a mini-skit event can occur (has been selected) based on the result of the random selection (S73). If, as a result of the determination, a mini-skit event can occur (YES in S73), the processor 81 sets the event‑availability data 338 for the processing target character. For example, the event ID 351 of the determined event, information specifying the correlation reference character (currently pinched character) as the event partner, parameters to be changed, the values by which the parameters are increased or decreased, etc., are set as appropriate. At this time, the mini-skit event has not yet occurred, and thus the parameters are not changed.

On the other hand, if, as a result of the determination in S73 above, no mini-skit event will occur (NO in S73), the process in S74 above is skipped.

Next, the processor 81 determines whether or not all virtual residents existing within the first correlation display range have been processed (S75). If any unprocessed virtual resident exists (NO in S75), the processor 81 returns to S71 above and repeats the processing. Therefore, if a plurality of virtual residents for which a mini-skit event can occur exist within the first correlation display range, each virtual resident performs the behavior of looking up at the currently pinched character. On the other hand, if all the virtual residents have been processed (YES in S75), the event occurrence determination process ends.

Referring back to FIG. 43, next, the processor 81 sets the nearest virtual resident within the first correlation display range as the correlation target character. Furthermore, based on the human relationship data 335 between the correlation reference character and the correlation target character, the processor 81 generates a correlation diagram image as described above and places the correlation diagram image at a predetermined position within the screen (S56). At this time, if the correlation target character has been grouped, a correlation diagram image for the members of that group (see FIG. 16) is generated. Then, the correlation diagram display control process ends.

On the other hand, if, as a result of the determination in S52 above, the current mode is the follow mode (YES in S52), next, the processor 81 determines whether or not at least one other virtual resident exists within the second correlation display range (S57). If no other virtual resident exists within the second correlation display range (NO in S57), the correlation diagram display control process ends. If at least one other virtual resident exists within the second correlation display range (YES in S57), the processor 81 sets the other virtual resident nearest to the correlation reference character (in this case, the follow target character) as the correlation target character (S58). Then, based on the human relationship data 335 between the correlation reference character and the correlation target character, the processor 81 generates and places a correlation diagram image as described above (S59). Then, the correlation diagram display control process ends.

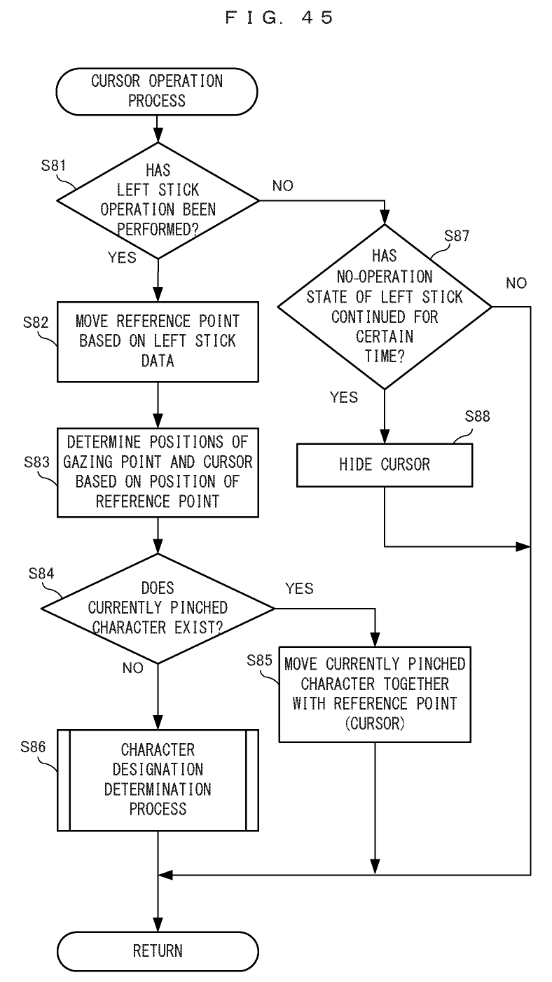

Referring back to FIG. 41, next, the processor 81 executes a cursor operation process (S24). FIG. 45 is a flowchart showing the details of the cursor operation process. First, the processor 81 determines whether or not a directional input operation has been performed on the left stick 32 (S81). If such an operation has been performed (YES in S81), the processor 81 moves the reference point based on the left stick data 363 (S82). Furthermore, the processor 81 determines the gazing point of the virtual camera based on the reference point, and sets the virtual camera control data 307 based on the gazing point. The processor 81 also determines the position of the cursor based on the reference point (S83). At this time, in the case of the overhead camera, the position of the finger‑shaped cursor is determined, and in the case of the ground camera, the position of the circular cursor is determined.

Next, the processor 81 determines whether or not a currently pinched character (a virtual resident for which the pinched state flag 340 is ON) exists (S84). If a currently pinched character exists (YES in S84), the processor 81 moves the currently pinched character together with the reference point (or cursor) (S85). Then, the cursor operation process ends.

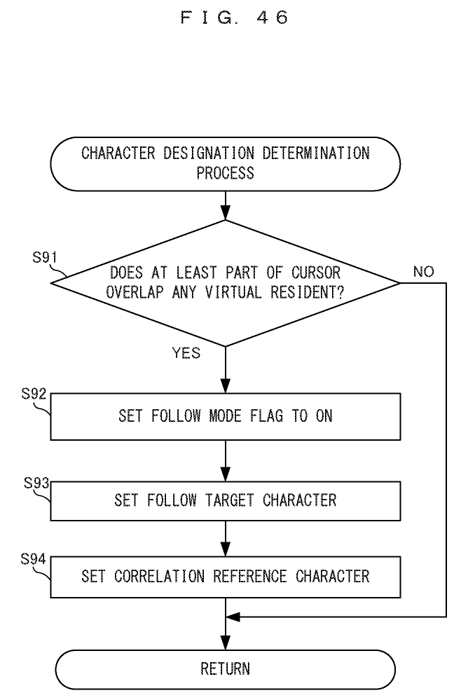

On the other hand, if no currently pinched character exists (NO in S84), the processor 81 executes a character designation determination process (S86). FIG. 46 is a flowchart showing the details of this process. In FIG. 46, first, the processor 81 determines whether or not at least a part of the finger‑shaped cursor overlaps any virtual resident (S91). If, as a result of the determination, at least a part of the finger‑shaped cursor overlaps any virtual resident (YES in S91), the processor 81 sets the follow mode flag 310 to ON (S92). Next, the processor 81 sets the virtual resident as the follow target character (S93). Furthermore, the processor 81 sets the virtual resident as the correlation reference character (S94).

On the other hand, if the finger‑shaped cursor does not overlap any virtual resident (NO in S91), the processes in S92 to S94 above are skipped. Then, the character designation determination process ends.

Referring back to FIG. 45, if the character designation determination process ends, the cursor operation process ends. On the other hand, if, as a result of the determination in S81 above, no directional input operation has been performed on the left stick 32 (NO in S81), the processor 81 determines whether or not the no‑operation state of the left stick 32 has continued for a predetermined time or longer (S87). If the no‑operation state has continued for the predetermined time or longer (YES in S87), the processor 81 hides the finger‑shaped cursor (S88). That is, even when no virtual resident has been specified, if the no‑operation state continues, the finger‑shaped cursor is hidden to make it easier to view the state of the virtual town. On the other hand, if the no‑operation state has not continued for the predetermined time or longer (NO in S87), the process in S88 is skipped. Then, the cursor operation process ends.

Referring back to FIG. 41, next, the processor 81 determines whether or not the follow mode flag 310 is ON (S25). If the follow mode flag 310 is ON (YES in S25), the free movement mode process ends. On the other hand, if the follow mode flag 310 is OFF (NO in S25), the processor 81 executes a dropping operation determination process (S26).

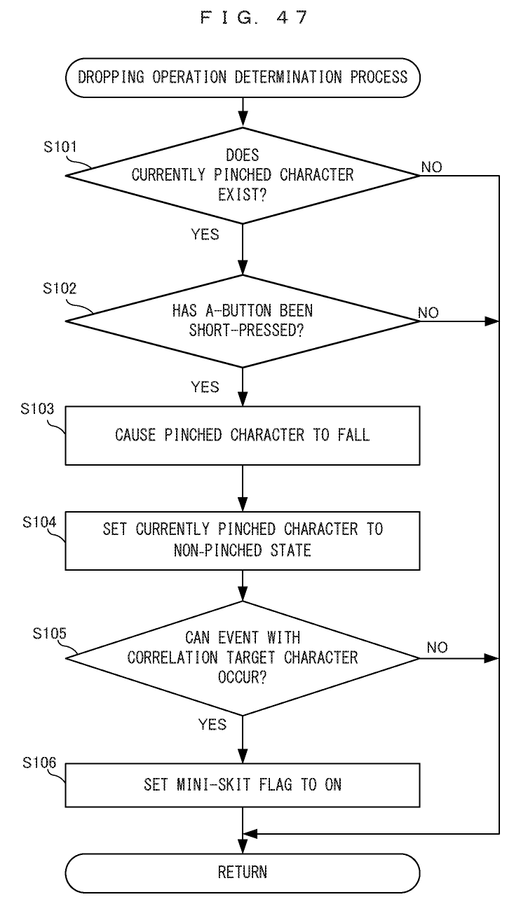

FIG. 47 is a flowchart showing the details of the dropping operation determination process. First, the processor 81 determines whether or not a currently pinched character exists (S101). If, as a result of the determination, a currently pinched character exists (YES in S101), next, the processor 81 determines whether or not the A-button 53 has been short-pressed (S102). If the A-button 53 has not been short-pressed (NO in S102), the dropping operation determination process ends. On the other hand, if the A-button 53 has been short-pressed (YES in S102), the processor 81 causes the currently pinched character to fall directly downward (S103). Furthermore, the processor 81 sets the currently pinched character to the “non‑pinched state” (S104).

Next, the processor 81 determines whether or not a mini-skit event can occur between the correlation target character at this time (the virtual resident for which a correlation diagram image has been displayed) and the dropped correlation reference character, based on the event‑availability data 338 (S105). If a mini-skit event can occur (YES in S105), the processor 81 sets the mini-skit flag 311 to ON (S106). If no mini-skit event can occur (NO in S105), the process in S106 is skipped.

On the other hand, if, as a result of the determination in S101 above, no currently pinched character exists (NO in S101), the processes in S102 to S106 above are skipped. Then, the dropping operation determination process ends.

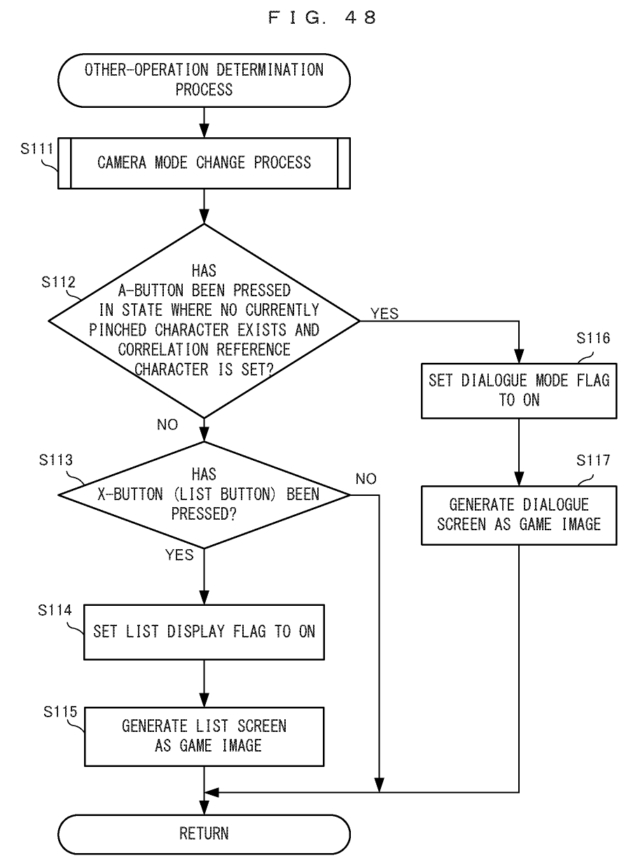

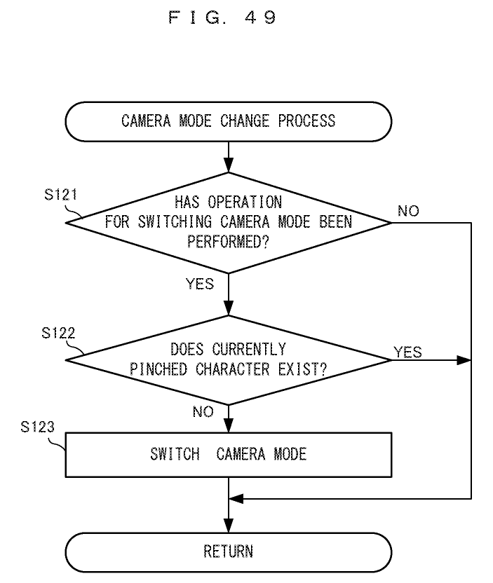

Referring back to FIG. 41, next, the processor 81 executes an other-operation determination process (S27). FIG. 48 is a flowchart showing the details of this process. In FIG. 48, first, the processor 81 executes a camera mode change process (S111). FIG. 49 is a flowchart showing the details of the camera mode change process. In FIG. 49, first, the processor 81 determines whether or not an operation for switching the camera mode (input in the up-down direction of the right stick 52) has been performed (S121). If no switching operation has been performed (NO in S121), the camera mode change process ends. If such a switching operation has been performed (YES in S121), the processor 81 determines whether or not a currently pinched character exists (S122). If no currently pinched character exists (NO in S122), the processor 81 switches the camera mode between the overhead camera and the ground camera according to the content of the operation (S123). On the other hand, if a currently pinched character exists (YES in S122), the process in S123 is skipped, and the camera mode change process ends.

Referring back to FIG. 48, next, the processor 81 determines whether or not a short-press operation has been performed on the A-button 53 in a state where no currently pinched character exists and a correlation reference character is set (S112). That is, it is determined whether or not an operation for transitioning to the dialogue screen has been performed. If, as a result of the determination, the operation for transitioning to the dialogue screen has been performed (YES in S112), the processor 81 sets the dialogue mode flag 312 to ON (S116). Next, the processor 81 generates the dialogue screen as shown in FIG. 20 (S117). Then, the other-operation determination process ends.

On the other hand, if no operation for transitioning to the dialogue screen has been performed (NO in S112), the processor 81 determines whether or not the X-button 55 has been pressed, that is, an operation for transitioning to the list screen has been performed (S113). If, as a result of the determination, the operation for transitioning to the list screen has been performed (YES in S113), the processor 81 sets the list display flag 313 to ON (S114). Next, the processor 81 generates a list screen as shown in FIG. 32 (without a correlation diagram image) or FIG. 33 (with a correlation diagram image) depending on whether a currently pinched character or a follow target character exists (S115). Then, the other-operation determination process ends. On the other hand, if no operation for transitioning to the list screen has been performed (NO in S113), the processes in S114 and S115 are skipped, and the other-operation determination process ends.

Referring back to FIG. 41, if the other-operation determination process ends, the free movement mode process ends.

### Follow mode process

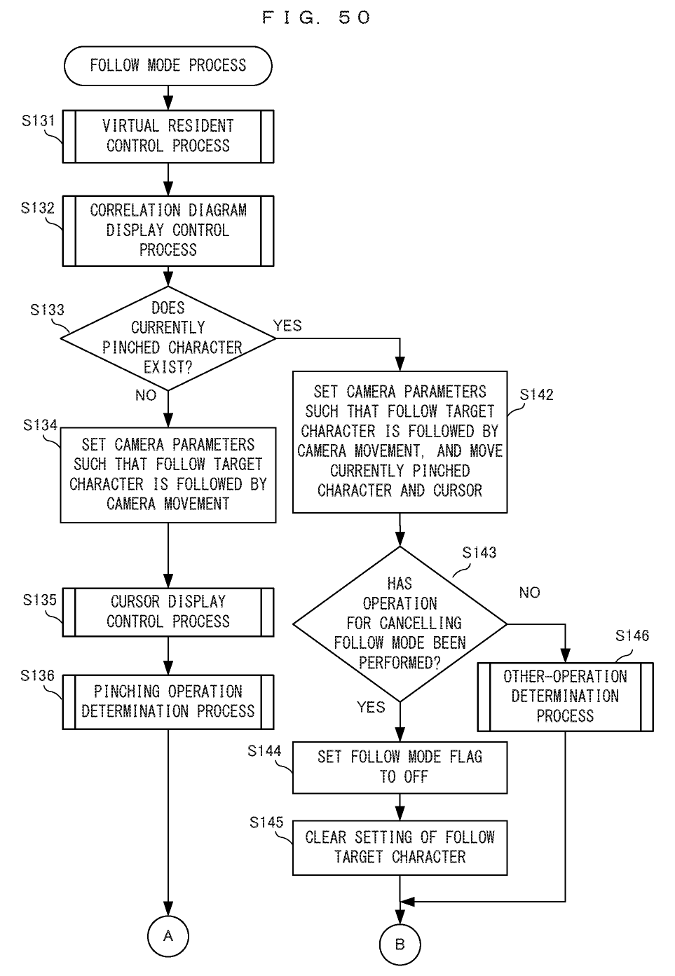

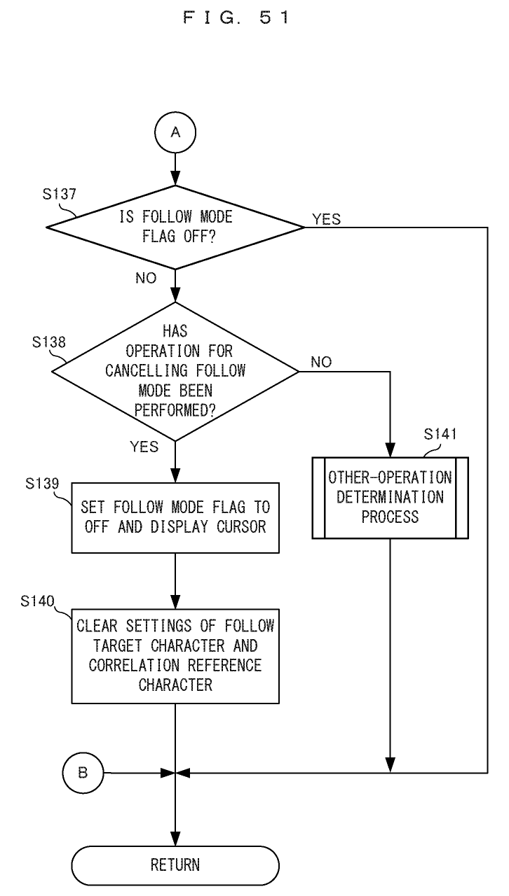

Next, the follow mode process in S10 in FIG. 40 will be described. FIG. 50 and FIG. 51 are flowcharts showing the details of the follow mode process. In FIG. 50, first, the processor 81 executes the virtual resident control process (S131). Next, the processor 81 executes the correlation diagram display control process (S132). These processes are the same as the processes described above using FIG. 42 and FIG. 43, and thus the description thereof is omitted.

Next, the processor 81 determines whether or not a currently pinched character exists (S133). If no currently pinched character exists (NO in S133), the processor 81 moves the reference point such that the reference point follows the follow target character, determines the gazing point of the virtual camera based on this, and sets the virtual camera control data 307 as appropriate (S134).

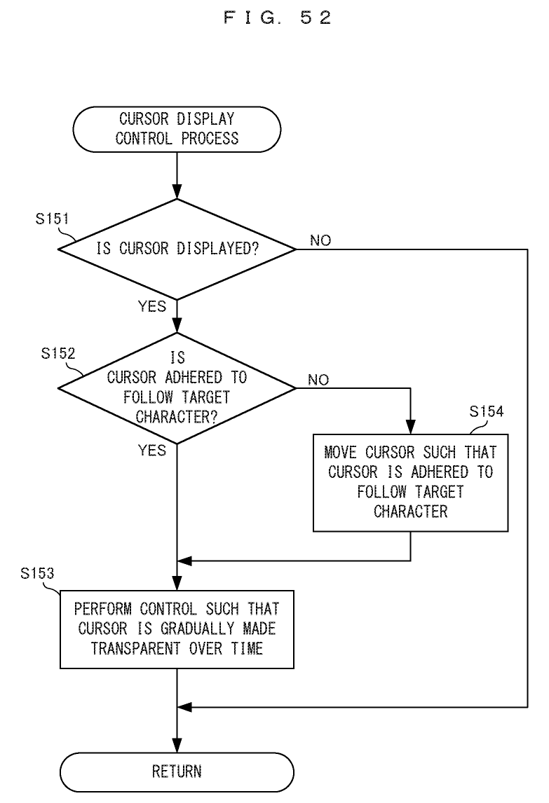

Next, the processor 81 executes a cursor display control process (S135). FIG. 52 is a flowchart showing the details of this process. First, the processor 81 determines whether or not the cursor is displayed (S151). If the cursor is not displayed (NO in S151), the cursor display control process ends. If the cursor is displayed (YES in S151), next, the processor 81 determines whether or not the cursor is adhered to the follow target character (S152). If the cursor is adhered to the follow target character (YES in S152), the processor 81 performs control in which the cursor is gradually made transparent over time (S153). On the other hand, if the cursor is not adhered to the follow target character (NO in S152), the processor 81 moves the cursor such that the cursor is adhered to the follow target character (S154). Then, the processor 81 proceeds to the process in S153 and performs control in which the cursor is gradually made transparent over time. Then, the cursor display control process ends.

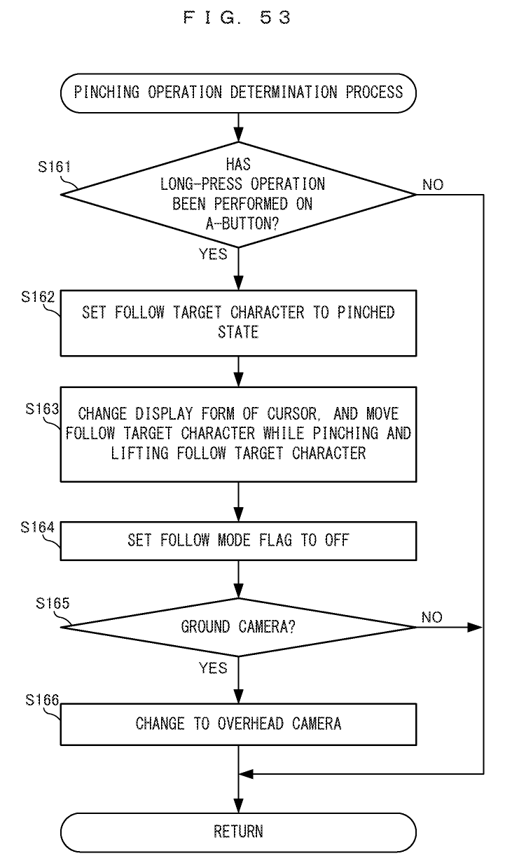

Referring back to FIG. 50, next, the processor 81 executes a pinching operation determination process (S136). FIG. 53 is a flowchart showing the details of the pinching operation determination process. First, the processor 81 determines whether or not a long-press operation (pinching operation) has been performed on the A-button 53 (S161). If, as a result of the determination, no long-press operation has been performed on the A-button 53 (NO in S161), the pinching operation determination process ends. On the other hand, if a long-press operation has been performed on the A-button 53 (YES in S161), the processor 81 sets the follow target character to the pinched state (S162). Accordingly, the follow target character will thereafter be treated as a currently pinched character.

Next, the processor 81 changes the image of the finger‑shaped cursor to an image of the finger‑shaped cursor pinching and lifting something, and moves the currently pinched character upward in the virtual space while pinching and lifting the currently pinched character (S163).

Next, the processor 81 sets the follow mode flag 310 to OFF (S164).

Next, the processor 81 determines whether or not the current camera mode is the ground camera (S165). If the current camera mode is the ground camera (YES in S165), the processor 81 changes the camera mode to the overhead camera (S166). If the current camera mode is not the ground camera (NO in S165), the process in S166 is skipped. Then, the pinching operation determination process ends.

Next, in FIG. 51, the processor 81 determines whether or not the follow mode flag 310 is OFF (S137). If, as a result of the determination, the follow mode flag 310 is OFF (YES in S137), the follow mode process ends. On the other hand, if the follow mode flag 310 is ON (NO in S137), next, the processor 81 determines whether or not an operation for cancelling the follow mode, specifically, a directional input operation on the left stick 32, has been performed (S138). If, as a result of the determination, the operation for cancelling the follow mode has been performed (YES in S138), the processor 81 sets the follow mode flag 310 to OFF. Furthermore, the processor 81 performs setting of displaying the cursor corresponding to the camera mode (overhead camera/ground camera) (S139).

Next, the processor 81 clears the follow target data 316 and the correlation target data 315, thereby canceling the settings of the follow target character and the correlation reference character (S140). Then, the follow mode process ends.

On the other hand, if, as a result of the determination in S138, no operation for cancelling the follow mode has been performed (NO in S138), the processor 81 executes an other-operation determination process (S141). This process is the same as the process described above using FIG. 48, and thus the description thereof is omitted. Then, the follow mode process ends.

Next, processing performed if, as a result of the determination in S133 in FIG. 50 above, a currently pinched character exists (YES in S133), will be described. This is processing performed in the case where: the screen has transitioned to the list screen in a state where a currently pinched character exists; and list movement has been performed. In this case, first, the processor 81 sets the parameters of the virtual camera such that the virtual camera moves to follow the follow target character. Although described later in a process related to the list screen, a virtual resident specified from the list is set as the follow target character in this case. Furthermore, the processor 81 moves the currently pinched character and the finger‑shaped cursor such that the currently pinched character and the finger‑shaped cursor follow the follow target character (S142).

Next, the processor 81 determines whether or not the same operation for cancelling the follow mode as described above has been performed (S143). If, as a result of the determination, the operation for cancelling the follow mode has been performed (YES in S143), the processor 81 sets the follow mode flag 310 to OFF (S144). Furthermore, the processor 81 cancels the setting of the follow target character (S145). Then, the follow mode process ends.

On the other hand, if no operation for cancelling the follow mode has been performed (NO in S143), the processor 81 executes the above-described other-operation determination process (S146). Then, the follow mode process ends.

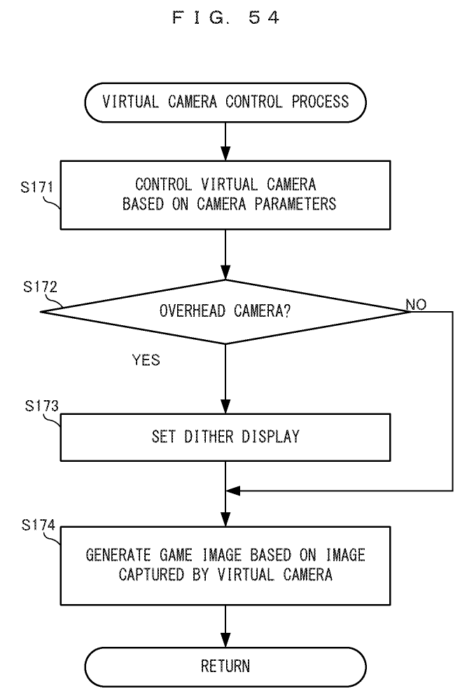

Referring back to FIG. 40, after the free movement mode process or the follow mode, the processor 81 executes a virtual camera control process (S11). FIG. 54 is a flowchart showing the details of the virtual camera control process. In FIG. 54, first, the processor 81 controls the position and the orientation of the virtual camera, based on the set content of the virtual camera control data 307 (S171). Next, the processor 81 determines whether or not the current camera mode is the overhead camera (S172). If the current camera mode is the overhead camera (YES in S172), the processor 81 sets the dither display described above (S173). For example, the processor 81 performs determination as to whether a virtual resident is blocked, by performing a raycast, and performs the setting of performing the dither display on a virtual resident determined to be blocked.

On the other hand, if the current camera mode is not the overhead camera (NO in S172), the process in S173 is skipped.

Next, the processor 81, for example, synthesizes various images, as necessary, in an image of the virtual space captured by the virtual camera, to generate a game image to be finally outputted (S174). Then, the virtual camera control process ends.

Referring back to FIG. 40, next, the processor 81 updates the human relationship parameters of each virtual resident, based on the result of the above processing (and the mini-skit event process and dialogue screen process described later) and the determined contents of changes of the human relationship parameters (S12). If the content of change of the mood parameter has also been determined, the processor 81 also changes the mood parameter accordingly.

Next, the processor 81 outputs the game image generated through the above processing (and the mini-skit event process, dialogue screen process, and list screen process described later), to a display unit such as a monitor (S13). Next, the processor 81 determines whether or not a condition for ending the game is satisfied (S14). If this condition is not satisfied (NO in S14), the processor 81 returns to S2 above and repeats the processing. If this condition is satisfied (YES in S14), the processor 81 ends the game processing.

### Mini-skit event process

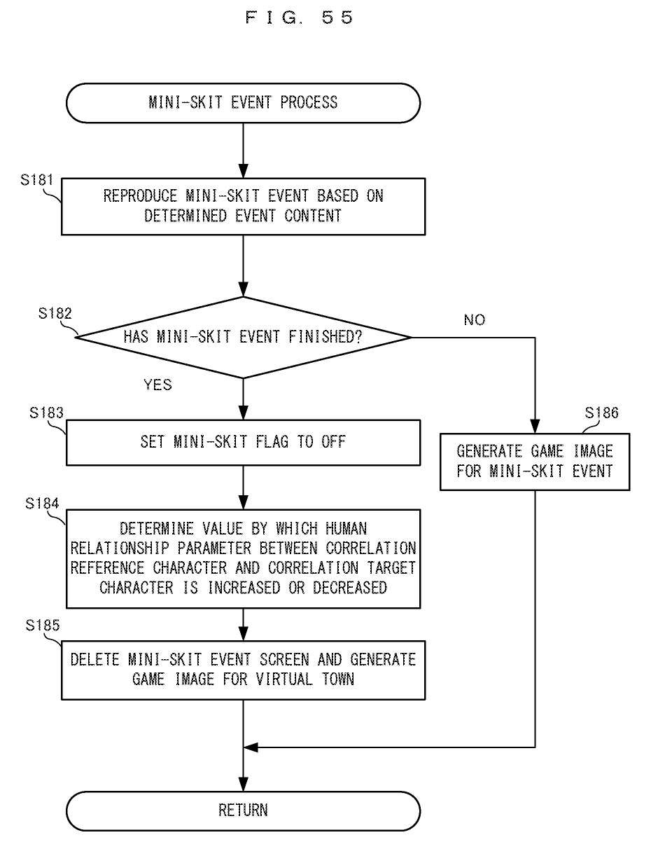

Next, the mini-skit event process (S3) executed if, as a result of the determination in S2 above, the mini-skit flag 311 is ON, will be described. FIG. 55 is a flowchart showing the details of the mini-skit event process. In FIG. 55, first, the processor 81 reproduces a mini-skit event, based on the event content (event definition data 309) determined through the processing described above (S181).

Next, the processor 81 determines whether or not the reproduction of the mini-skit event has finished (S182). If the reproduction of the mini-skit event has not finished (NO in S182), the processor 81 generates a game image for the mini-skit event (S186). Then, the mini-skit event process ends.

On the other hand, if the reproduction has finished (YES in S182), the processor 81 sets the mini-skit flag 311 to OFF (S183). Next, the processor 81 determines the value by which the human relationship parameter between the correlation reference character and the correlation target character is increased or decreased, according to the content of the mini-skit event (S184). In addition, at this time, the contents of changes of the mood parameters may be determined.

The timing to determine the values by which the human relationship parameter and the mood parameters are increased or decreased is not limited to the above, and these values may instead be determined in advance at the start of the mini-skit event. Also, depending on the event content, etc., the parameters may not necessarily be changed.

Next, the processor 81 deletes the mini-skit event screen and generates a game image for the virtual town (S185). Then, the mini-skit event process ends.

### Dialogue screen process

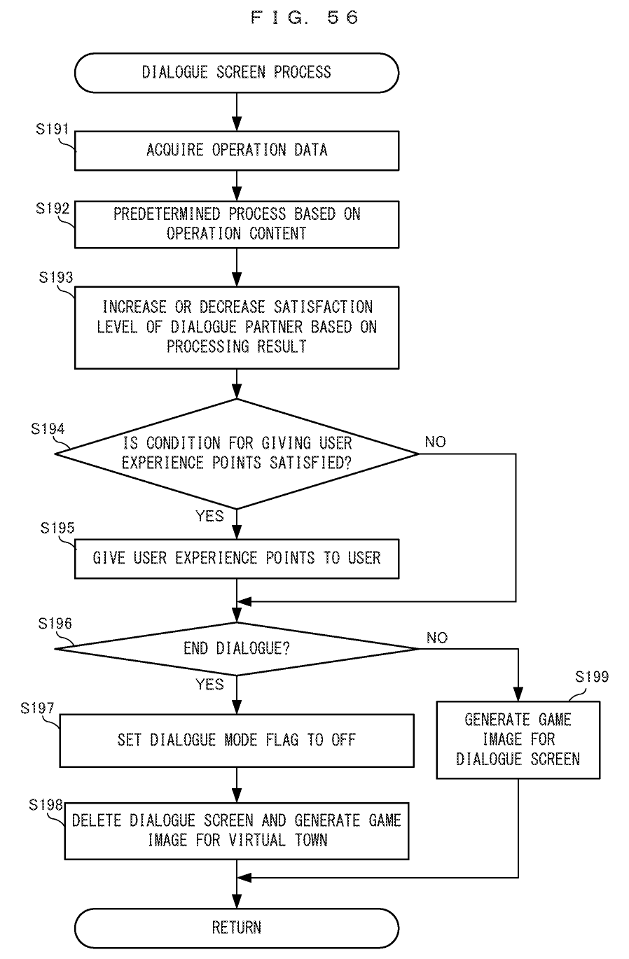

Referring back to FIG. 40, next, the dialogue screen process (S5) executed if, as a result of the determination in S4 above, the dialogue mode flag 312 is ON, will be described. FIG. 56 is a flowchart showing the details of the dialogue screen process. In FIG. 56, first, the processor 81 acquires the operation data 317 (S191). Next, the processor 81 executes a predetermined process related to the dialogue screen, based on the operation content (S192). For example, a process of giving an item to a virtual resident as a gift may be executed based on an operation performed by the user on the user action instruction region. In addition, for example, a process of providing advice in response to a concern consultation from a virtual resident may be executed.

Next, the processor 81 changes the satisfaction level of the virtual resident who is the dialogue partner, based on the result of the above processing (S193). At this time, if the satisfaction level reaches a certain value, the processor 81 levels up that virtual resident. In addition to the satisfaction level, the processor 81 may determine to change the mood parameter and determine the content of the change. Based on the change content determined here, the mood parameter can be updated in the process in S12 above.

Next, the processor 81 determines whether or not a condition for the dialogue partner to give the above user experience points to the user is satisfied (S194). If, as a result of the determination, this condition is satisfied (YES in S194), the processor 81 gives the user experience points to the user (S195). On the other hand, if this condition is not satisfied (NO in S194), the process in S195 is skipped.

Next, the processor 81 determines whether or not a condition for ending the dialogue screen is satisfied (S196). For example, it is determined whether an ending operation has been performed by the user. If the ending condition is not satisfied (NO in S196), the processor 81 generates a game image for the dialogue screen (S199). On the other hand, if the ending condition is satisfied (YES in S196), the processor 81 sets the dialogue mode flag 312 to OFF (S197). Next, the processor 81 deletes the dialogue screen and generates a game image for the virtual town (S198). Then, the dialogue screen process ends.

### List screen process

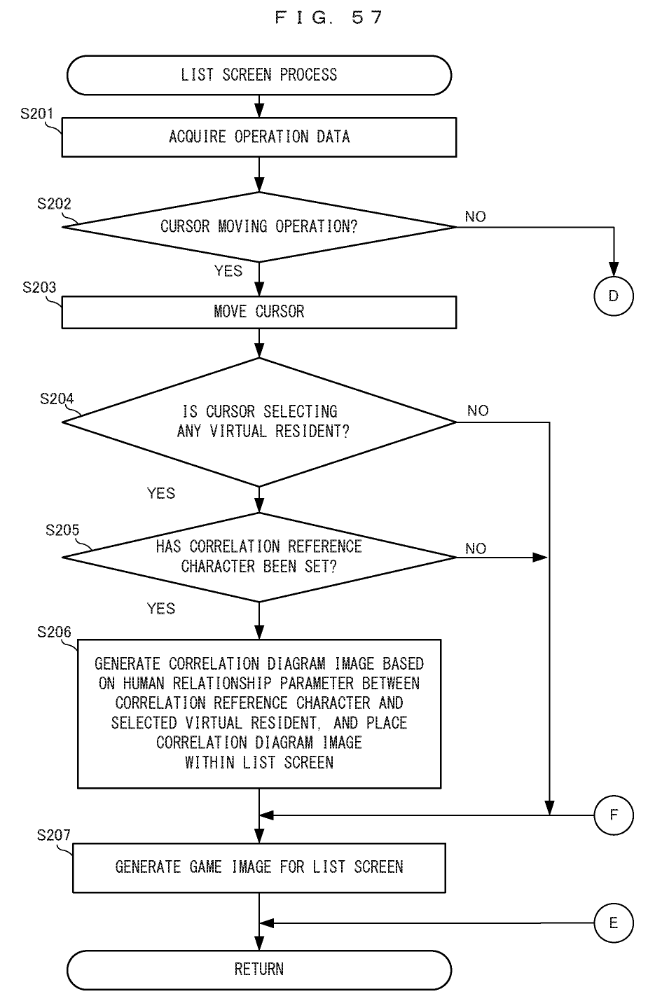

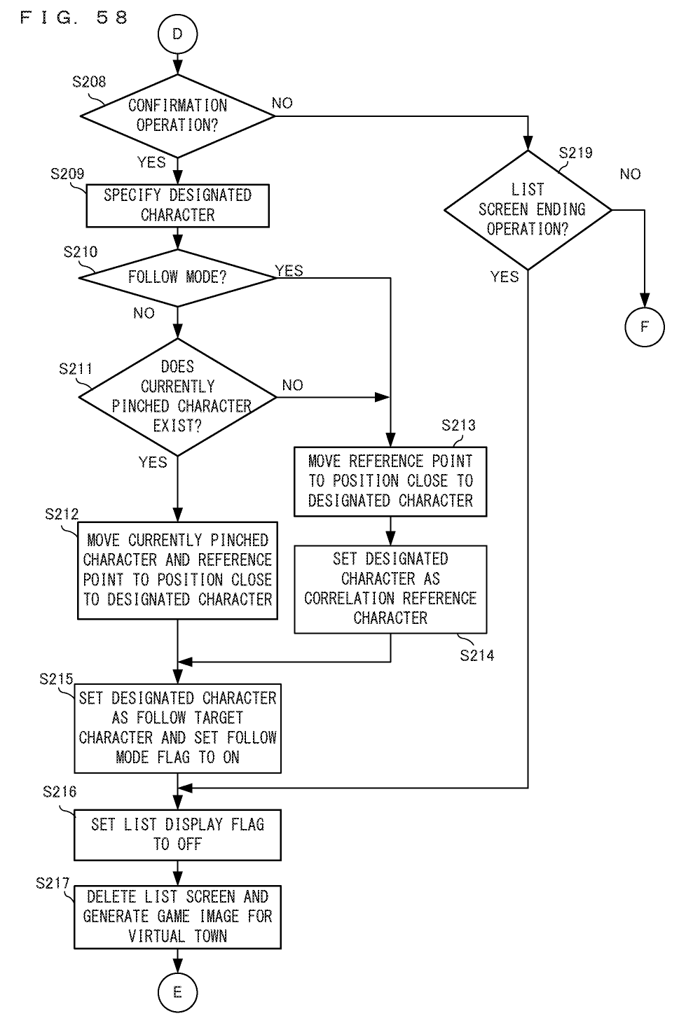

Referring back to FIG. 40, next, a list screen process (S7) executed if, as a result of the determination in S6 above, the list display flag 313 is ON, will be described. FIG. 57 and FIG. 58 are flowcharts showing the details of the list screen process. In FIG. 57, first, the processor 81 acquires the operation data 317 (S201).

Next, the processor 81 determines whether or not an operation for moving the list cursor has been performed (S202). If an operation for moving the list cursor has been performed (YES in S202), the processor 81 moves the list cursor based on the left stick data 363 (S203).

Next, the processor 81 determines whether or not the list cursor is selecting the face icon of any virtual resident in the list (S204). If the list cursor is selecting the face icon of any virtual resident (YES in S204), the processor 81 determines whether or not the correlation reference character has been set (S205). If, as a result of the determination, the correlation reference character has been set (YES in S205), the processor 81 generates the above correlation diagram image, based on the human relationship data 335 between the correlation reference character and the selected virtual resident. Then, the processor 81 places the correlation diagram image at a predetermined position within the list screen (S206).

On the other hand, if no correlation reference character has been set (NO in S205), the process in S206 is skipped.

If, as a result of the determination in S204 above, the list cursor is not selecting the face icon of any virtual resident (NO in S204), the processes in S205 and S206 above are skipped. Next, the processor 81 generates a list screen reflecting the above processing, as a game image (S207). Then, the list screen process ends.

On the other hand, if, as a result of the determination in S202 above, no operation for moving the list cursor has been performed (NO in S202), next, the processor 81 determines whether or not a confirmation operation (pressing the A-button 53) has been performed in a state where any virtual resident has been selected (S208). If, as a result of the determination, the confirmation operation has been performed (YES in S208), the processor 81 specifies the selected virtual resident as a virtual resident designated as a movement destination (designated character) (S209).

Next, the processor 81 determines whether or not the current mode is the follow mode (S210). If the current mode is not the follow mode (NO in S210), next, the processor 81 determines whether or not a currently pinched character exists (S211). If a currently pinched character exists (YES in S211), the processor 81 moves the reference point and the currently pinched character to a position close to the designated character. Furthermore, the positions of the cursor and the virtual camera (gazing point) are also determined based on the reference point after the movement (S212). At this time, setting may be performed such that a representation in which the reference point and the currently pinched character move from the current position to the movement destination with screen scrolling over a predetermined time, is displayed. Also, in this case, since the movement is completed with the pinched state maintained, the pinched state remains even after the list screen is closed. Therefore, in order to bring the currently pinched character to meet the designated character, it is necessary to separately perform the “dropping operation” after the list screen is closed.

On the other hand, if, as a result of the determination in S211 above, no currently pinched character exists (NO in S211), the processor 81 moves the reference point to a position close to the designated character. Furthermore, the positions of the cursor and the virtual camera (gazing point) are also determined based on the reference point after the movement (S213).

Next, the processor 81 sets the designated character as the correlation reference character (S214).

Next, the processor 81 sets the designated character as the follow target character. Furthermore, the processor 81 sets the follow mode flag 310 to ON (S215).

Next, the processor 81 sets the list display flag 313 to OFF (S216). Next, the processor 81 deletes the list screen and generates a game image for the virtual town (S217). Then, the list screen process ends.

On the other hand, if, as a result of the determination in S210 above, the current mode is the follow mode (YES in S210), the processor 81 proceeds to the process in S213 above, and the reference point is moved to a position close to the designated character.

On the other hand, if, as a result of the determination in S208 above, the confirmation operation has not been performed (NO in S208), next, the processor 81 determines whether or not an operation for ending the list screen has been performed (S219). If the operation for ending the list screen has been performed (YES in S219), the processor 81 advances the processing to S216 above. If no operation for ending the list screen has been performed (NO in S219), the processor 81 advances the processing to S207 above.

This is the end of the detailed description of the game processing according to the exemplary embodiment.

As described above, in this game, in a game in which the user can observe the lives of virtual residents and the human relationship between virtual residents changes as a result of the occurrence of an event, the user can bring a virtual resident to meet another virtual resident through the pinching and dropping operations as described above. This allows the user to somewhat actively attempt to cause an event to occur. Furthermore, by performing control such that the correlation diagram image is displayed as appropriate as described above, it is possible to determine whether to cause an event to occur, while confirming the status of the human relationship parameters.

### Modifications

In the above embodiment, the reference point is moved in the world coordinate system, but the reference point may be moved in a screen coordinate system.

In the above embodiment, the cursor position and the gazing point are determined based on the reference point, but in another exemplary embodiment, the reference point does not have to be used. For example, one or both of the cursor and the gazing point may be directly controlled based on a directional input of the left stick 32. Alternatively, for example, when the cursor is operated with the left stick 32, the gazing point may be determined based on the position of the cursor, or vice versa.

In the above embodiment, the user moves a virtual resident in the manner of pinching and lifting the virtual resident and then moving the visual resident. However, the moving manner is not limited thereto, and in another exemplary embodiment, for example, the user may be allowed to “possess” a virtual resident and thereby move the virtual resident directly.

In the above example, as for the determination as to whether to switch to the follow mode, the case where a part of the finger‑shaped cursor overlaps a virtual resident has been described as an example, but in another exemplary embodiment, switching to the follow mode may be performed when the finger‑shaped cursor approaches the virtual resident. For example, if a predetermined range centered on each virtual resident is set as a “follow determination range”, when the finger‑shaped cursor enters the follow determination range of any virtual resident, this virtual resident may be set as the follow target character, and switching to the follow mode may be performed. The size of the follow determination range in this case may be the same as or different from the size of the first correlation display range or second correlation display range described above.

In another exemplary embodiment, the timing to display the correlation diagram image may be controlled as follows.

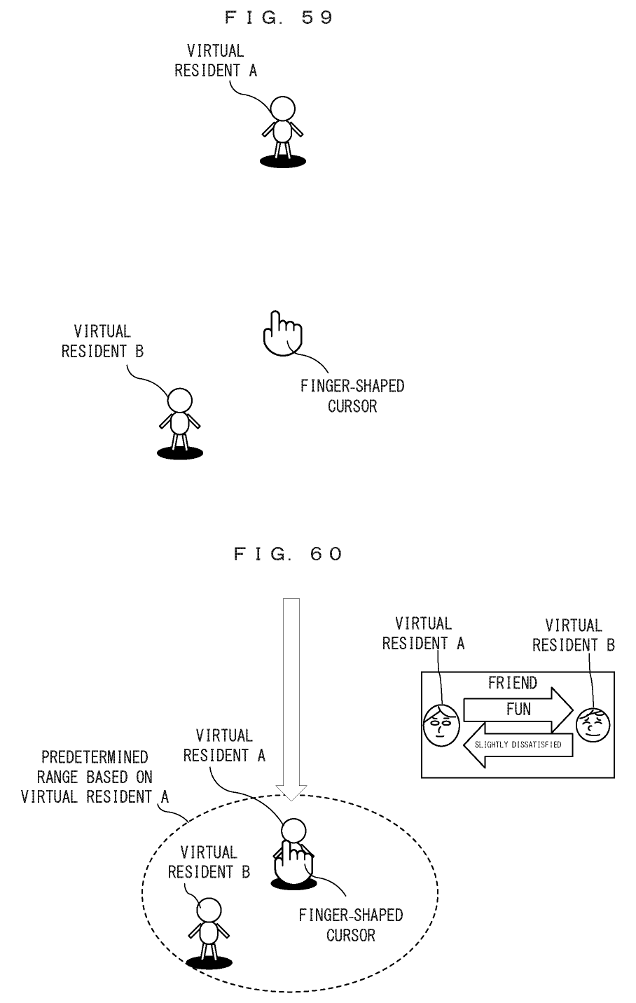

First, when, in the follow mode, a virtual resident in a non‑pinched state autonomously moves and ends up overlapping a cursor, if another virtual resident is also nearby, a correlation diagram image with the virtual resident inside the cursor may be displayed. For example, the case where the positional relationship among the cursor, a virtual resident A, and a virtual resident B is a positional relationship shown in FIG. 59 is assumed. Then, from this state, the virtual resident A moves and reaches a position overlapping the (stationary) cursor as shown in FIG. 60. In this case, the virtual resident A may be set as the correlation reference character, and if the virtual resident B is within a predetermined range from the virtual resident A, a correlation diagram image for the virtual resident A and the virtual resident B may be displayed as shown in FIG. 60. In addition, the size of this predetermined range may be the same as or different from the size of the first correlation display range or second correlation display range described above.

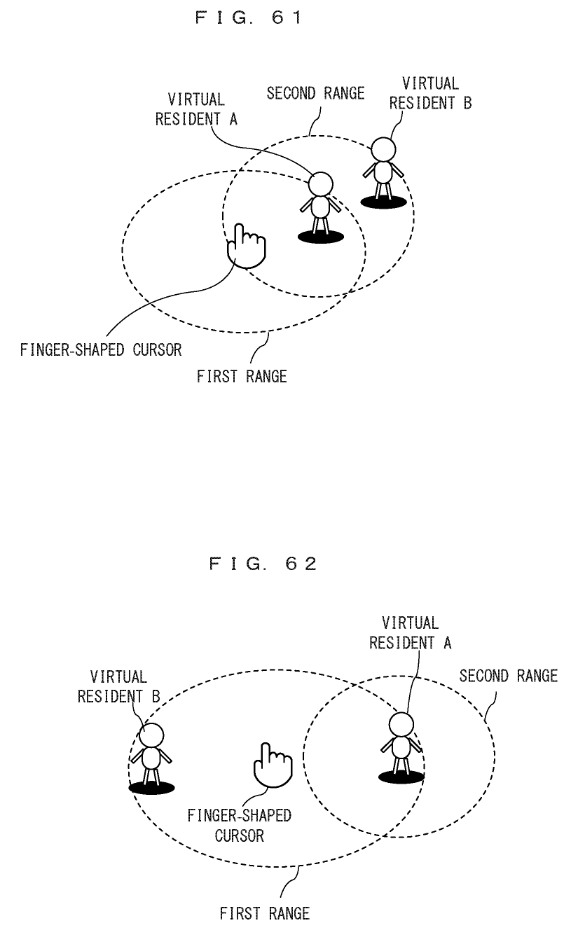

Furthermore, as shown in FIG. 61, if the virtual resident A exists within a predetermined range (referred to as first range) based on the cursor, the virtual resident A may be set as the correlation reference character. Then, if another virtual resident exists within a predetermined range (referred to as second range) based on the virtual resident A, a correlation diagram image for both residents may be displayed. The sizes of the first range and the second range may be the same as or different from the size of the first correlation display range, the second correlation display range, or the follow determination range.

Moreover, as shown in FIG. 62, when the virtual resident A exists within the first range based on the cursor and the virtual resident B also exists within the first range, a correlation diagram image for both residents may be displayed. In the example of FIG. 62, the virtual resident B does not exist within the second range of the virtual resident A.

As for the first correlation display range, in another exemplary embodiment, whether to display a correlation diagram image may be determined using a collision region having a circular column shape instead of a circular region.

In another exemplary embodiment, in the free movement mode, it may be possible to transition a virtual resident into a pinched state without transitioning to the follow mode. For example, a long-press operation may be performed in advance on the A-button 53, and when the finger‑shaped cursor overlaps a virtual resident, control in which the virtual resident is brought into a pinched state may be performed.

As for the dither display, in addition to the display form described above, a blocked portion of a virtual resident may be made semi-transparent or may be displayed as a silhouette.

As for the in‑game currency, in the above example, in‑game currency is provided by each virtual resident, and the higher the satisfaction level, the greater the amount of in‑game currency provided. In this regard, for example, if the satisfaction level is less than a predetermined value, in‑game currency may not necessarily be provided. That is, in‑game currency may be provided only by each virtual resident whose satisfaction level is equal to or greater than the predetermined value.

For example, the above processor 81 may mean one or more processors in one apparatus such as a main body apparatus or may mean some or all of one or more processors included in each of multiple apparatuses such as a main body apparatus and a controller or a main body apparatus, a controller, and a server. The same applies to the memory of the information processing system and other components.

The program that causes a computer to execute each process may be a single program or may be a program group including a plurality of programs. The “certain program” does not necessarily mean a single program and may include a program group. In addition, the entirety of the program does not need to be stored in one apparatus. The “certain program” may mean, for example, the totality of programs that are stored in a plurality of apparatuses included in the information processing system, respectively.

In an information processing system including a terminal-side apparatus and a server-side apparatus capable of communicating via a network, at least part of the series of processes described above may be executed by the server-side apparatus. The server may be composed of a plurality of information processing apparatuses, and the processes may be executed by the plurality of information processing apparatuses in a shared manner.

While the exemplary embodiment and the modifications have been described, the description thereof is in all aspects illustrative and not restrictive. It is to be understood that various other modifications and variations may be made to the exemplary embodiment and the modifications.

While the present disclosure has been described in detail, the foregoing description is in all aspects illustrative and not restrictive. It is to be understood that numerous other modifications and variations can be devised without departing from the scope of the present disclosure.

What is claimed is:

1. One or more non-transitory computer-readable storage media having stored therein instructions that, when executed, cause one or more processors to perform operations comprising:
in response to an operation input, transitioning a state of a first character, among a plurality of characters placed within a virtual space, from a first state to a second state;
in response to an operation input, moving the first character in the second state within the virtual space;
when the first character is in the second state and a second character among the plurality of characters is placed within a first range based on a position of the first character, displaying a parameter UI indicating a first parameter regarding a combination of the first character and the second character;
in response to an operation input, transitioning the state of the first character from the second state to the first state; and
when at least the UI indicating the first parameter is displayed, if the state of the first character is transitioned from the second state to the first state, causing an in‑game event, through which the first parameter is updated, to occur.

2. The one or more non-transitory computer-readable storage media according to claim 1, wherein the operations further comprise moving the first character in the first state within the virtual space, not based on an operation input by a user.

3. The one or more non-transitory computer-readable storage media according to claim 2, wherein the operations further comprise:
generating a game image, based on a virtual camera within the virtual space; and
in response to a switching instruction based on an operation input,
switching between a first camera mode in which the virtual camera is moved based on an operation input and a second camera mode in which the virtual camera is moved so as to follow movement of a character in the first state.

4. The one or more non-transitory computer-readable storage media according to claim 3, wherein the operations further comprise
in the first camera mode:
displaying a cursor UI indicating a position within the virtual space, the indicated position changing in response to an operation input; and
when the position indicated by the cursor UI is included within a second range based on the position of the first character in the first state, switching to the second camera mode.

5. The one or more non-transitory computer-readable storage media according to claim 3, wherein the operations further comprise
in the second camera mode,
when the second character is placed within a third range based on the position of the first character followed by the virtual camera, displaying the UI indicating the first parameter.

6. The one or more non-transitory computer-readable storage media according to claim 3, wherein the operations further comprise
in the second camera mode:
displaying at least one or some of icons respectively corresponding to the plurality of characters, based on an operation input;
displaying a UI indicating the first parameter regarding a combination of a character corresponding to the icon selected by an icon selection instruction based on an operation input and the first character followed by the virtual camera; and
when an icon determination instruction based on an operation input is made for the selected icon, moving the first character to a position based on a position of the character corresponding to the icon.

7. The one or more non-transitory computer-readable storage media according to claim 6, wherein
the operations further comprise, when the icon determination instruction based on an operation input is made for the selected icon, moving the first character in the second state to a position based on the position of the character corresponding to the icon, and
the first character in the second state is moved such that the first character follows the character corresponding to the icon.

8. The one or more non-transitory computer-readable storage media according to claim 2, wherein the operations further comprise:
displaying a cursor UI indicating a position within the virtual space, the indicated position changing in response to an operation input; and
when a character determination instruction based on an operation input is made in a state where the cursor UI overlaps the first character in the first state, transitioning the state of the first character from the first state to the second state.

9. The one or more non-transitory computer-readable storage media according to claim 8, wherein the operations further comprise, when the first character in the first state is placed within a fourth range based on the position indicated by the cursor UI and the second character is placed within the first range based on the position of the first character, displaying the UI indicating the first parameter regarding a combination of the first character and the second character.

10. The one or more non-transitory computer-readable storage media according to claim 1, wherein the operations further comprise:
generating a game image, based on a virtual camera within the virtual space;
changing a distance between the virtual camera and a virtual surface on which the first character is placed, based on an operation input;
when the virtual surface and the virtual camera are separated from each other by more than a first distance and the first character is blocked by another object as seen from the virtual camera, displaying the other object so as to show that the first character is blocked; and
when a determination instruction based on an operation input is made for the first character blocked by the other object, transitioning the state of the first character from the first state to the second state.

11. The one or more non-transitory computer-readable storage media according to claim 10, wherein the operations further comprise, when a state of a third character is the second state, placing the virtual camera at a position separated from the virtual surface by more than the first distance.

12. The one or more non-transitory computer-readable storage media according to claim 10, wherein the operations further comprise, when the distance between the virtual surface and the virtual camera is within the first distance and the first character is blocked by another object as seen from the virtual camera, displaying the other object without showing that the first character is blocked.

13. The one or more non-transitory computer-readable storage media according to claim 1, wherein
the operations further comprise:
when the first character is in the second state and the second character among the plurality of characters is placed within the first range based on the position of the first character, further displaying a relationship UI indicating a relationship between the first character and the second character; and
when a first condition which is satisfied at least by the first parameter reaching a first threshold value is satisfied, transitioning the relationship between the first character and the second character from a first relationship to a second relationship, and
the first parameter is updated such that the first parameter satisfies the first condition, through the in‑game event.

14. The one or more non-transitory computer-readable storage media according to claim 13, wherein types of the in‑game events occurring in the second relationship are more than types of the in‑game events occurring in the first relationship.

15. The one or more non-transitory computer-readable storage media according to claim 13, wherein the operations further comprise
while a second parameter of the first character satisfies a second condition:
restricting occurrence of the in‑game event through which the first parameter of the first character and the second character having the first relationship with the first character is updated; and
when at least the first parameter regarding a combination of the second character and the first character is indicated, if the state of the second character is transitioned from the second state to the first state, changing the second parameter such that the second condition is not satisfied.

16. The one or more non-transitory computer-readable storage media according to claim 13, wherein the operations further comprise:
when the second parameter of the first character does not satisfy the second condition and a third condition based on the first character is satisfied based on an operation input, updating a third parameter of the first character; and
when the second parameter of the first character satisfies the second condition and the third condition is satisfied based on an operation input, restricting update of the third parameter of the first character.

17. The one or more non-transitory computer-readable storage media according to claim 16, wherein
the operations further comprise giving a first in-game item to a user at a specified timing, and
an amount of the first in-game item given to the user when the third parameter of the first character has reached a second threshold value is greater than an amount of the first in-game item given to the user when the third parameter of the first character has not reached the second threshold value.

18. The one or more non-transitory computer-readable storage media according to claim 15, wherein the operations further comprise giving a second in-game item to a user when a second parameter of the first character satisfies a fourth condition in accordance with the in‑game event based on the operation input.

19. A game apparatus comprising
one or more processors, and
one or more non-transitory computer-readable storage media having stored therein instructions that, when executed, cause the one or more processors to perform operations comprising:
in response to an operation input, transitioning a state of a first character, among a plurality of characters placed within a virtual space, from a first state to a second state;
in response to an operation input, moving the first character in the second state within the virtual space;
when the first character is in the second state and a second character among the plurality of characters is placed within a first range based on a position of the first character, displaying a parameter UI indicating a first parameter regarding a combination of the first character and the second character;
in response to an operation input, transitioning the state of the first character from the second state to the first state; and
when at least the UI indicating the first parameter is displayed, if the state of the first character is transitioned from the second state to the first state, causing an in‑game event, through which the first parameter is updated, to occur.

20. A game system comprising
one or more processors, and
one or more non-transitory computer-readable storage media having stored therein instructions that, when executed, cause the one or more processors to perform operations comprising:
in response to an operation input, transitioning a state of a first character, among a plurality of characters placed within a virtual space, from a first state to a second state;
in response to an operation input, moving the first character in the second state within the virtual space;
when the first character is in the second state and a second character among the plurality of characters is placed within a first range based on a position of the first character, displaying a parameter UI indicating a first parameter regarding a combination of the first character and the second character;
in response to an operation input, transitioning the state of the first character from the second state to the first state; and
when at least the UI indicating the first parameter is displayed, if the state of the first character is transitioned from the second state to the first state, causing an in‑game event, through which the first parameter is updated, to occur.

21. A computer-implemented method comprising:
in response to an operation input, transitioning a state of a first character, among a plurality of characters placed within a virtual space, from a first state to a second state;
in response to an operation input, moving the first character in the second state within the virtual space;
when the first character is in the second state and a second character among the plurality of characters is placed within a first range based on a position of the first character, displaying a parameter UI indicating a first parameter regarding a combination of the first character and the second character;
in response to an operation input, transitioning the state of the first character from the second state to the first state; and
when at least the UI indicating the first parameter is displayed, if the state of the first character is transitioned from the second state to the first state, causing an in‑game event, through which the first parameter is updated, to occur.
